(19) United States
(12) Patent Application Publication
(10) Pub. No.: US 2010/0145776 A1
(43) Pub. Date: Jun. 10, 2010

(54) IN-VEHICLE APPARATUS AND SEMICONDUCTOR DEVICE

(75) Inventors: Osamu Eguchi, Kuwana-city (JP); Shouichirou Hanai, Anjo-city (JP); Kenta Hayashi, Nagoya-city (JP)

Correspondence Address: HARNESS, DICKEY & PIERCE, P.L.C., P.O. BOX 828, BLOOMFIELD HILLS, MI, 48303, US

(73) Assignee: Denso Corporation, Aichi-pref (JP)

(21) Appl. No.: 12/598,464

(22) PCT Filed: May 7, 2008
(86) PCT No.: PCT/JP2008/001153

§ 371 Date: Nov. 2, 2009

(30) Foreign Application Priority Data
May 11, 2007 (JP) 2007 126934
Apr. 25, 2008 (JP) 2008 115458

(51) Int. Cl. G07B 15/00

(52) U.S. Cl. 705/13

(57) ABSTRACT

The in-vehicle apparatus card information stored in a storage section is set to an inactive state and is prevented from being read from the storage section when an ignition switch changes from “on” to “off” or when a user performs an operation signifying a change from an active state to the inactive state. Accordingly, the in-vehicle apparatus card information is disabled by an explicit user operation or a normal operation performed when the user gets out of a vehicle. It is possible to prevent the unauthorized use of the in-vehicle apparatus card information when the user does not get in the vehicle.

### CROSS REFERENCES TO RELATED APPLICATIONS

The present invention contains subject matter related to Japanese Patent Application JP 2007-126934 filed in the Japanese Patent Office on May 11, 2007, and Japanese Patent Application JP 2008-115458 filed in the Japanese Patent Office on Apr. 25, 2008, the entire contents of which being incorporated herein by reference.

### TECHNICAL FIELD

The present invention relates to an in-vehicle apparatus and the like capable of a charging process for toll fare and the like.

### BACKGROUND ART

In recent years, an electronic toll collection (ETC) system is widely used. According to the present ETC system, however, a contact IC card is inserted into an in-vehicle apparatus. There are disadvantages such as a contact failure between the IC card and the in-vehicle apparatus and a failure on the part of the driver to insert the IC card, preventing the vehicle from normally passing through an entrance or exit gate of the ETC system.

To address the above noted disadvantages, then, applicants of the present invention previously applied the invention (Japanese Published Unexamined Patent Application No. 2008-092539) in which card information is copied from an IC card in advance and the copied card information is used for passing through a gate, making it possible to pass through the gate without using the IC card.

Generally, however, an ETC in-vehicle apparatus is fixed to the vehicle. According to the above-mentioned technology, the card information remains at the vehicle after a user leaves the vehicle. Such a state may be unfavorable for the following reasons.

(1) The user may feel the above-mentioned state to be the same as leaving the IC card at the vehicle and may feel uneasy from the viewpoint of crime prevention.

(2) From the viewpoint of crime prevention, a credit card company to issue IC cards or a road management corporate may also consider it unfavorable that the information virtually equivalent to the IC card to be always carried and managed by the user is left staying at the unattended vehicle.

Consequently, it may be possible to erase the card information stored in the in-vehicle apparatus when an ignition switch is turned off. When the card information is erased in such a manner, however, the card information needs to be stored anew in the in-vehicle apparatus each time the card information is needed. Such a requirement is inconvenient for the user. In addition, the card information is highly confidential and should not be leaked. The card information needs to be stored in the in-vehicle apparatus in a highly secure manner. Accordingly, a process for storing the card information in the in-vehicle apparatus requires a longer time than a process for storing less confidential information in the in-vehicle apparatus. That is, the usability of the in-vehicle apparatus degrades.

### DISCLOSURE OF THE INVENTION

The present invention has been made in consideration of the foregoing. It is an object of the present invention to provide an in-vehicle apparatus and the like capable of preventing the unauthorized use of card information while maintaining the usability as much as possible when a user leaves his or her vehicle after storing the card information available for a charging process in the in-vehicle apparatus.

As an example of the present invention, an in-vehicle apparatus includes: a charging execution section that communicates with a roadside apparatus and executes a charging process; a charging information storage section that stores charging information needed to execute the charging process by the charging execution section; and a setup section that assigns one of an active state equivalent to an available state and an inactive state equivalent to an unavailable state to the charging information stored in the charging information storage section.

As another example of the invention, a semiconductor device has a configuration described with respect to the setup section in the above-mentioned in-vehicle apparatus.

As still another example of the invention, a semiconductor device is characterized by assigning one of an active state equivalent to an available state and an inactive state equivalent to an unavailable state to charging information needed to execute a charging process.

### BRIEF DESCRIPTION OF THE DRAWINGS

The above and other objects, features, and advantages of the present invention will be apparent from the following detailed description of the preferred embodiments of the invention in conjunction with the accompanying drawings, in which:

FIG. 1 is a block diagram illustrating an overall configuration of an ETC system;

FIG. 2 is a block diagram illustrating a detailed configuration of an in-vehicle apparatus and a portable terminal;

FIG. 3 is a flow chart illustrating a flow of using the in-vehicle apparatus;

FIG. 4 is an explanatory diagram illustrating an overall process of registering in-vehicle apparatus card information to the portable terminal;

FIG. 5 is a ladder chart illustrating details of registering in-vehicle apparatus card information to the portable terminal;

FIG. 6 is a ladder chart illustrating a process in which a salesperson at a shop of the in-vehicle apparatus registers in-vehicle apparatus card information to the in-vehicle apparatus;

FIG. 7 is a flow chart illustrating an in-vehicle apparatus process;

FIG. 8 is a flow chart illustrating a state change process;

FIG. 9 is a flow chart illustrating an automatic activation setup process 1;

FIG. 10 is a flow chart illustrating an automatic activation setup process 2;

FIG. 11 is a flow chart illustrating an in-vehicle apparatus card information erasure process;

FIG. 12 is a flow chart illustrating a notification process; and

FIG. 13 is an explanatory diagram illustrating a configuration of an in-vehicle apparatus card information table when multiple elements of in-vehicle apparatus card information are stored.

### BEST MODES FOR CARRYING OUT THE INVENTION

Embodiments of the present invention will be described in further detail with reference to the accompanying drawings. The embodiments of the invention are not limited to the following. Various modifications may be made to the embodiments within the technical scope of the invention.

(Description of the Configuration)

(1) Overall Configuration

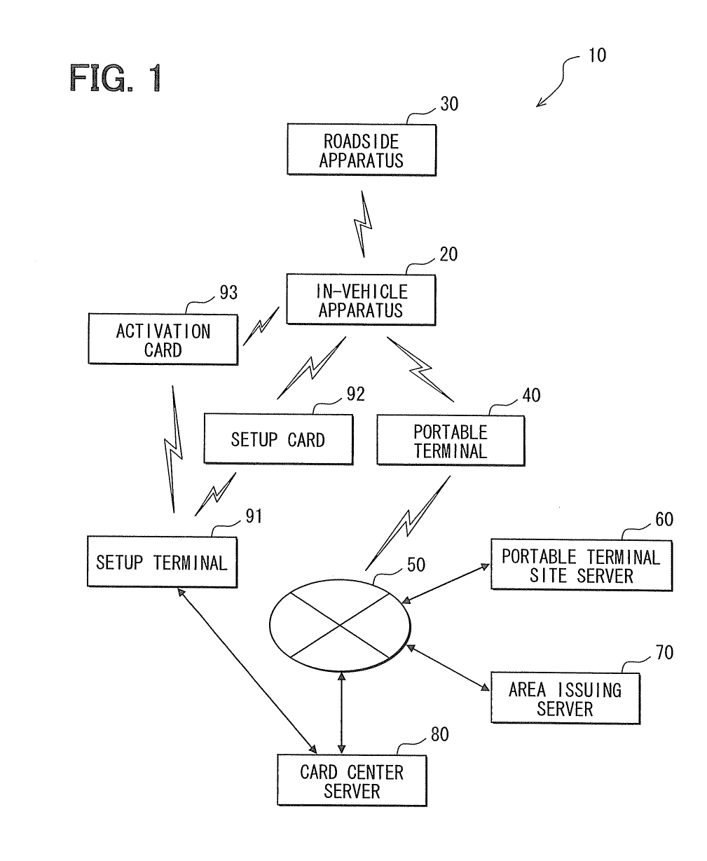

FIG. 1 is a block diagram showing an overall configuration of an ETC system 10. The ETC system 10 includes an in-vehicle apparatus 20, a roadside apparatus 30, a portable terminal 40, a portable terminal site server 60, an area issuing server 70, a card center server 80, a setup terminal 91, a setup card 92, and an activation card 93. The in-vehicle apparatus 20 is mounted on a vehicle. The roadside apparatus 30 is installed at a tollbooth or elsewhere. The portable terminal 40 can be carried by a user. The portable terminal site server 60 provides a website for the portable terminal 40. The area issuing server 70 provides information for setting a storage area in a storage medium (a storage section 46 to be described later) provided for the portable terminal 40. The card center server 80 is installed at a credit card company. The setup terminal 91 sets up the in-vehicle apparatus 20. The setup card 92 is used for setup. The activation card 93 activates in-vehicle apparatus card information stored in the in-vehicle apparatus 20. The in-vehicle apparatus card information is read from the in-vehicle apparatus 20 as needed and is used for a charging process. Incidentally, FIG. 1 shows each one of these components. Generally, each component is available more than one. Further, Dedicated Short Range Communication (DSRC) is used between the in-vehicle apparatus 20 and the roadside apparatus 30. Furthermore, near field communication is used between the in-vehicle apparatus 20 and the portable terminal 40, between the in-vehicle apparatus 20 and the setup card 92, between the in-vehicle apparatus 20 and the activation card 93, between the setup card 92 and the setup terminal 91, and between the activation card 93 and the setup terminal 91. Moreover, a wireless public line network 50 is used for communication between the portable terminal 40 and each of the portable terminal site server 60, the area issuing server 70, and the card center server 80. Incidentally, the portable terminal 40 and the wireless public line network 50 are connected wirelessly. Each of the servers and the wireless public line network 50 are connected through a wired connection. Still further, the setup terminal 91 communicates with the card center server 80 through an unshown communication network such as the Internet.

(2) In-Vehicle Apparatus 20

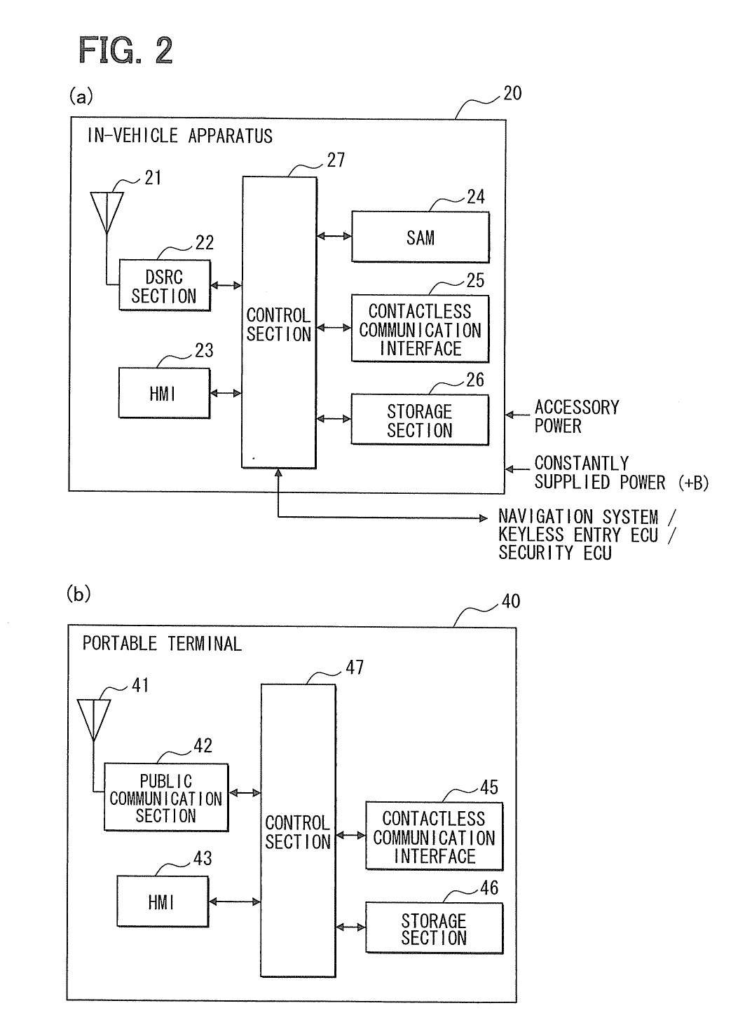

The in-vehicle apparatus 20 will be described in detail with reference to a block diagram in FIG. 2 part (a). The in-vehicle apparatus 20 includes a wireless antenna 21, a DSRC section 22 in which the section can be replaced by a device, HMI 23, SAM 24, a contactless communication interface 25, a storage section 26 in which the section can be replaced by a device, and a control section 27 in which the section can be replaced by a device.

The wireless antenna 21 is used for DSRC.

The DSRC section 22 transmits and receives information using DSRC through the wireless antenna 21. Incidentally, the DSRC section 22 communicates with the roadside apparatus 30.

The HMI 23 provides a human-machine interface (HMI) for communication between a person and the apparatus. Specifically, the HMI 23 includes an operation button, LED, speaker, and the like.

The SAM 24 encrypts and decrypts information exchanged with the roadside apparatus 30. The SAM 24 encrypts and decrypts information (management number, type registration number, vehicle number, and the like) specific to the in-vehicle apparatus. Further, the SAM 24 also encrypts and decrypts in-vehicle apparatus card information to be described later.

The contactless communication interface 25 provides contactless near field communication with the portable terminal 40, the setup card 92, and the activation card 93. Incidentally, the near field communication is available with such systems as Bluetooth (registered trademark), NEC (Near Field Communication), and UWB (Ultra Wide Band), for example. Further, the in-vehicle apparatus 20 may include a contact communication interface instead of or in addition to the contactless communication interface 25.

The storage section 26 includes flash memory representative of a device that needs no storage operations. The storage section 26 can store various types of information.

The control section 27 includes a CPU, ROM, RAM, I/O, and the like. The control section 27 centrally controls the DSRC section 22, the HMI 23, the SAM 24, the contactless communication interface 25, and the storage section 26 based on programs. Incidentally, the control section 27 can also communicate with a navigation system including or excluding the in-vehicle apparatus 20, a keyless entry ECU, and a security ECU. Further, the control section 27 contains an unshown battery and can operate at least with the storage section 26 during execution of an automatic activation setup process 2 to be described later even when no power is supplied.

(3) Roadside Apparatus 30

The roadside apparatus 30 will then be described. The roadside apparatus 30 has functions of exchanging information with the in-vehicle apparatus 20 using DSRC, decrypting encrypted information transmitted from the in-vehicle apparatus 20, encrypting information to be transmitted to the in-vehicle apparatus 20, and communicating with an unshown information center through wired communication. The information center manages the roadside apparatus 30. Incidentally, the information center has a function of performing a payment process such as billing a credit card company based on charging process information transmitted from the roadside apparatus 30.

(4) Portable Terminal 40

The portable terminal 40 will then be described in detail with reference to the block diagram in FIG. 2 part (b). The portable terminal 40 includes a wireless antenna 41, a public communication section 42 in which the section can be replaced by a device, an HMI 43, a contactless communication interface 45, a storage section 46 in which the section can be replaced by a device, and a control section 47 in which the section can be replaced by a device.

The wireless antenna 41 is used for wireless communication with the wireless public line network 50.

The public communication section 42 provides wireless communication such as CDMA using the wireless antenna 41. Incidentally, the public communication section 42 finally communicates with a portable terminal site server 60, an area issuing server 70, and a card center server 80.

The HMI 43 provides a human-machine interface for communication between a person and the apparatus. Specifically, the HMI 43 includes an operation button, liquid crystal panel, speaker, microphone, and the like.

The contactless communication interface 45 provides communication with the in-vehicle apparatus 20. The contactless communication interface 45 communicates with not only the in-vehicle apparatus 20 but also the other apparatuses capable of contactless near field communication. Incidentally, the near field communication is available with such systems as Bluetooth (registered trademark), NFC (Near Field Communication), and UWB (Ultra Wide Band), for example. Further, the portable terminal 40 may include a contact communication interface instead of or in addition to the contactless communication interface 45.

The storage section 46 includes flash memory representative of a device that needs no storage operations. The storage section 46 can store various types of information.

The control section 47 includes a CPU, ROM, RAM, I/O, and the like. The control section 47 centrally controls the public communication section 42, the HMI 43, the contactless communication interface 45, and the storage section 46 based on programs.

(5) Portable Terminal Site Server 60

The portable terminal site server 60 will then be described. The portable terminal site server 60 has functions of storing HTML data for the portable terminal 40, a setup application (AP) to be operated on the portable terminal 40, and the like, transmitting the stored data and the like to the portable terminal 40 via the wireless public line network 50, and the like.

(6) Area Issuing Server 70

The area issuing server 70 will then be described. The area issuing server 70 has functions of storing information (ETC area creation information) needed for the portable terminal 40 to create an ETC area in the storage section 46, transmitting the ETC area creation information to the portable terminal 40 via the wireless public line network 50, and the like.

(7) Card Center Server 80

The card center server 80 will then be described. The card center server 80 has functions of communicating with the portable terminal 40 via the wireless public line network 50, decrypting information encrypted by the in-vehicle apparatus 20, encrypting information to be transmitted to the in-vehicle apparatus 20, generating in-vehicle apparatus card information based on information such as a specified ID and the like, communicating with the setup terminal 91, and the like.

(8) Setup Terminal 91

The setup terminal 91 will then be described. The setup terminal 91 is used to set up or store in-vehicle apparatus card information in the in-vehicle apparatus 20. The setup terminal 91 is installed at a shop, a vehicle sales dealer, and the like of the in-vehicle apparatus 20. The setup terminal 91 has functions of communicating with the card center server 80 via an unshown communication network such as the Internet, communicating with the setup card 92 using the near field communication, communicating the activation card 93 using the near field communication, an HMI function, and the like. The setup terminal 91 may have a function of setting up or storing vehicle information and the like in the in-vehicle apparatus 20. Further, the near field communication is available with such systems as Bluetooth (registered trademark), NFC (Near Field Communication), and UWB (Ultra Wide Band), for example.

(9) Setup Card 92

The setup card 92 will then be described. The setup card 92 is a contactless IC card and has functions of receiving and storing in-vehicle apparatus card information and the like from the setup terminal 91 using the near field communication, transmitting in-vehicle apparatus card information and the like to the in-vehicle apparatus 20 using the near field communication, and the like. Incidentally, the near field communication is available with such systems as Bluetooth (registered trademark), NFC (Near Field Communication), and UWB (Ultra Wide Band), for example.

(10) Activation Card 93

The activation card 93 will then be described. The activation card 93 has a function of receiving and storing activation card information from the setup terminal 91 using the near field communication. The activation card information is used for activating the in-vehicle apparatus card information stored in the in-vehicle apparatus 20. For example, the activation card information is unique to an activation card and is capable of specifying the activation card. The activation card 93 has also a function of transmitting the activation card information to the in-vehicle apparatus 20 using the near field communication and the like. Incidentally, the near field communication is available with such systems as Bluetooth (registered trademark), NFC (Near Field Communication), and UWB (Ultra Wide Band), for example.

(Description of Operations)

Operations of the ETC system will then be described. However, the following description centers on topics associated with the present invention. Description of processes described in Japanese Published Unexamined Patent Application No. 2008-092539 such as a charging process performed at a tollbooth gate or, more specifically, a process in which in-vehicle apparatus card information stored in the in-vehicle apparatus 20 is passed to the roadside apparatus 30 for charging is omitted.

(1) Flow of Using the in-Vehicle Apparatus 20

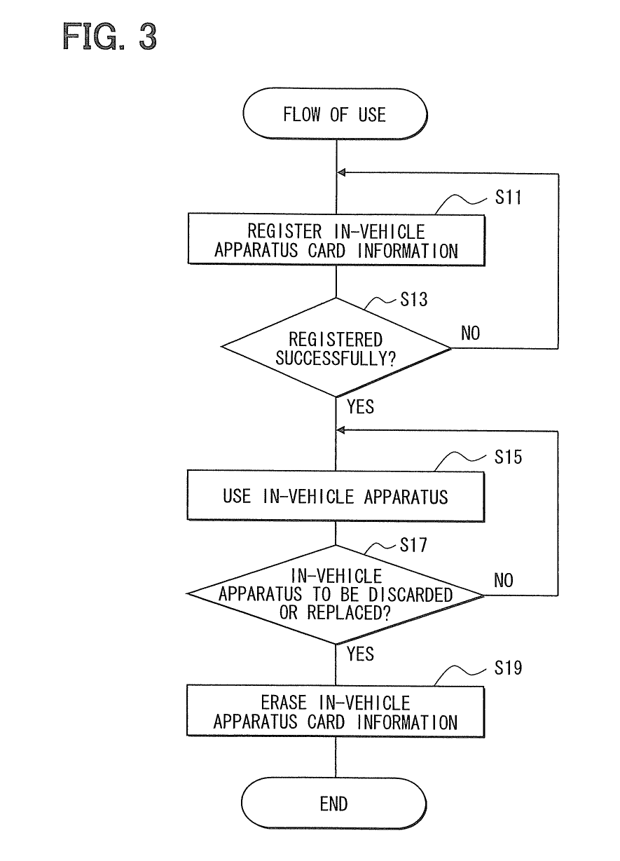

With reference to a flow chart in FIG. 3, the following first describes a sequence of operations in which a user starts the use of the in-vehicle apparatus 20 and finally terminates the same (discard or replace).

The user first needs to register the in-vehicle apparatus card information to the in-vehicle apparatus 20 (S11). The registration method is broadly classified into two types. One method is intended for the user himself or herself of the in-vehicle apparatus 20 through the use of the portable terminal 40. The other method is intended for a shop, a vehicle sales dealer, and the like of the in-vehicle apparatus 20. The above described methods will be described in detail later.

When the in-vehicle apparatus card information is successfully registered to the in-vehicle apparatus 20 (Yes at S13), the in-vehicle apparatus 20 is ready for use (S15). That is, when the vehicle mounted with the in-vehicle apparatus 20 travels a toll road, a charging process is performed using the in-vehicle apparatus card information registered to the in-vehicle apparatus 20. Incidentally, the in-vehicle apparatus card information is available in two states: an active state in which the in-vehicle apparatus card information is available for the charging process; and an inactive state in which the in-vehicle apparatus card information is unavailable for the charging process. Further, changing from the inactive state to the active state requires doing one of the following: placing the portable terminal 40 over the in-vehicle apparatus 209, in which case the portable terminal 40 is used for storing the in-vehicle apparatus card information in the in-vehicle apparatus 20; entering a private code to the in-vehicle apparatus 20, in which case the private code is entered when the in-vehicle apparatus card information is stored in the in-vehicle apparatus 20; and placing an activation card over the in-vehicle apparatus 20, in which case the activation card is created when the in-vehicle apparatus card information is stored in the in-vehicle apparatus 20. However, the in-vehicle apparatus card information automatically enters the active state when an automatic activation flag (to be described) is “on.” Moreover, in the first place, the in-vehicle apparatus card information for the in-vehicle apparatus 20 cannot be available (active state) unless the in-vehicle apparatus card information is normally registered to the in-vehicle apparatus 20 (No at S13).

When the in-vehicle apparatus 20 is used and then is discarded or replaced (Yes at S17), the user erases the in-vehicle apparatus card information registered to the in-vehicle apparatus 20 (S19). The erasure process will be described later.

(2) Method 1 of Registering the in-Vehicle Apparatus Card Information

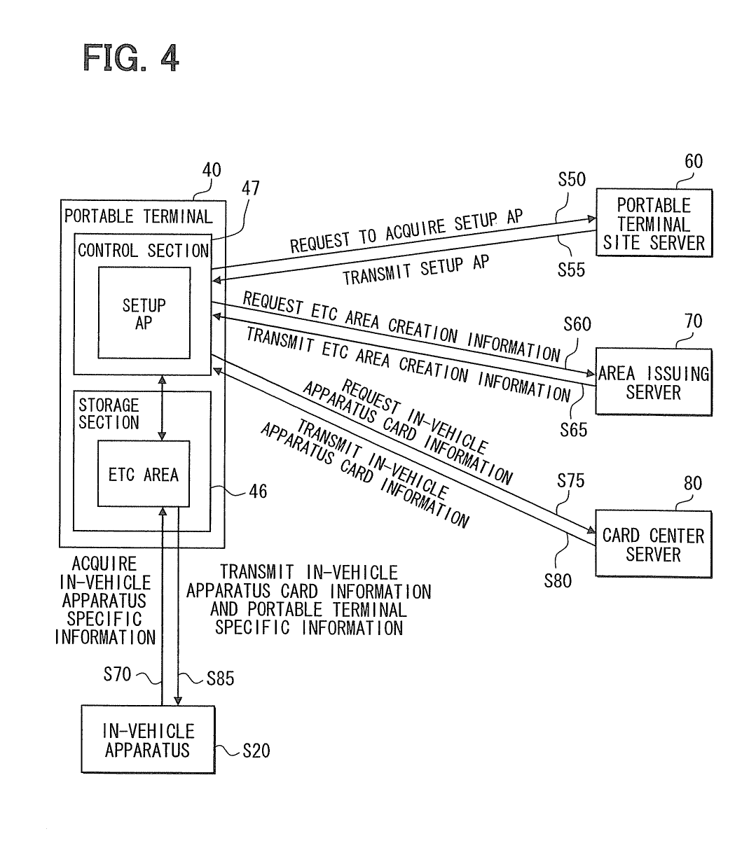

With reference to an explanatory diagram in FIG. 4, the following describes an overview of the process in which the user himself or herself of the in-vehicle apparatus 20 uses the portable terminal 40 to register in-vehicle apparatus card information to the in-vehicle apparatus 20.

The control section 47 of the portable terminal 40 receives a request command for acquiring a setup AP from the user via the HMI 43 (specifically an operation button) and then requests the portable terminal site server 60 to transmit the setup AP via the wireless public line network 50 (S50).

The portable terminal site server 60 receives the request and transmits the specified setup AP to the portable terminal 40 via the wireless public line network 50 (S55).

The control section 47 of the portable terminal 40 receives the setup AP, starts executing the setup AP, and issues a request for the ETC area creation information to the area issuing server 70 via the wireless public line network 50. In such a case, the “ETC area creation information” is used for ensuring a storage region (area) for specific card information in the storage section 46 of the portable terminal 40.

The area issuing server 70 receives the request for the ETC area creation information and generates the information (ETC area creation information) needed for creating an ETC area in the portable terminal 40. The area issuing server 70 transmits the generated information to the portable terminal 40 via the wireless public line network 50 (S65).

The control section 47 of the portable terminal 40 receives the ETC area creation information and generates the ETC area in the storage section 46 using the received ETC area creation information.

Thereafter, the control section 47 of the portable terminal 40 acquires a command from the user via the HMI 43 (specifically an operation button), in which case the command is to acquire the in-vehicle apparatus card information from the card center server 80 and to register the information to the in-vehicle apparatus 20. The control section 47 first communicates with the in-vehicle apparatus 20 via the contactless communication interface 45, acquires in-vehicle apparatus specific information (management number, type registration number, vehicle number, and the like) from the in-vehicle apparatus 20, and stores the information in the ETC area of the storage section 46 (S70). The control section 47 then requests the card center server 80 to transmit the in-vehicle apparatus card information via the wireless public line network 50 (S75).

The card center server 80 receives the request, generates the in-vehicle apparatus card information, encrypts the generated in-vehicle apparatus card information, and transmits the information to the portable terminal 40 via the wireless public line network 50 (S80).

The control section 47 of the portable terminal 40 receives the in-vehicle apparatus card information and stores the received in-vehicle apparatus card information in the ETC area of the storage section 46.

After storing the received in-vehicle apparatus card information in the ETC area of the storage section 46, the control section 47 of the portable terminal 40 transmits portable terminal specific information along with the in-vehicle apparatus card information to the in-vehicle apparatus 20. The portable terminal specific information is specific to the portable terminal 40.

According to the above described process, the in-vehicle apparatus card information as well as the portable terminal specific information are registered to the in-vehicle apparatus 20.

(3) Details of the Registration

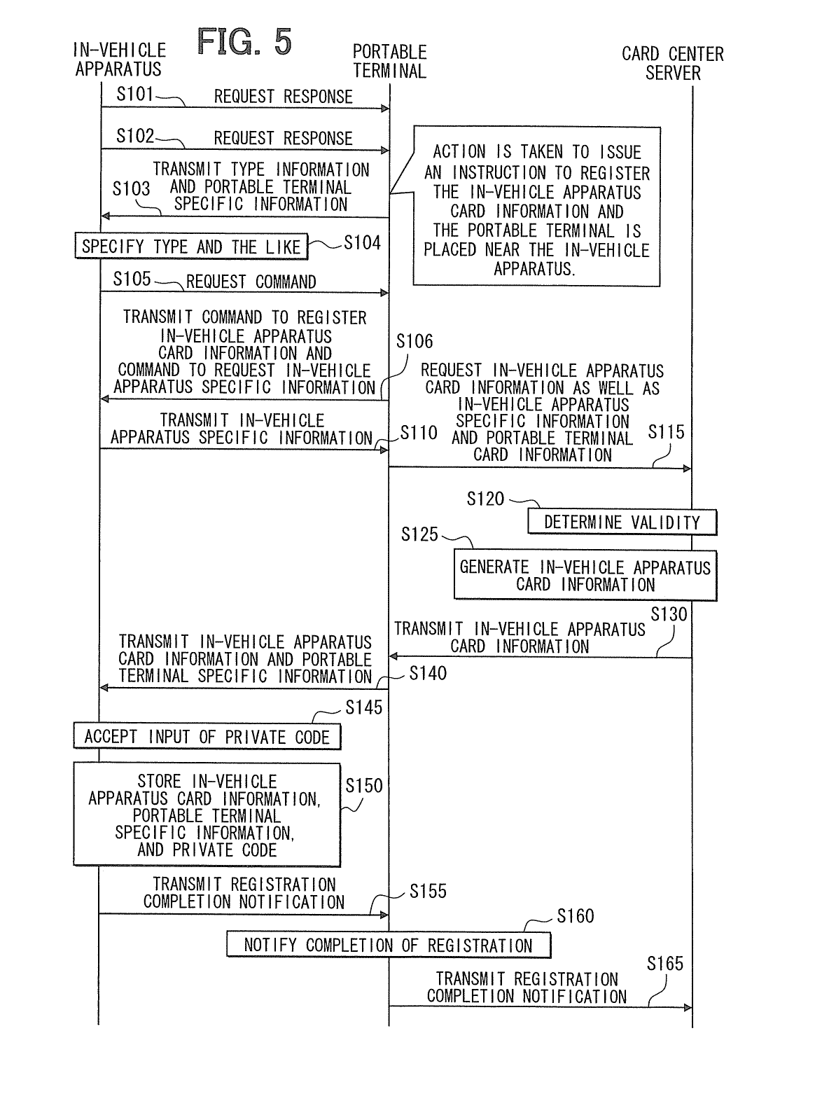

With reference to a ladder chart in FIG. 5, the following then describes details of the above-mentioned process (mainly S70 through S80) after the HMI 43 (specifically an operation button) is used to accept the command to acquire the in-vehicle apparatus card information from the card center server 80 and register the information to the in-vehicle apparatus 20.

The control section 27 of the in-vehicle apparatus 20 issues a response request at a specified cycle via the contactless communication interface 25 and performs an operation to await a response (S101 and S102). In the above described situation, the portable terminal 40 accepting a specified command from the user is placed near the in-vehicle apparatus 20. That is, the portable terminal 40 is placed near a range capable of the near field communication for the in-vehicle apparatus 20. The control section 47 of the portable terminal 40 responds to the response request from the in-vehicle apparatus 20 and transmits type information indicating the portable terminal and the portable terminal specific information stored in the storage section 46 to the in-vehicle apparatus 20 via the contactless communication interface 45 (S103). In the present context, “the portable terminal 40 accepting a specified command from the user” is one that accepts the command for registering the in-vehicle apparatus card information to the in-vehicle apparatus 20 from the user via the HMI 43 (specifically an operation button). Further, the “portable terminal specific information” signifies information specific to the portable terminal 40. Specifically, for example, the portable terminal specific information may represent a hardware-specific ID of the portable terminal 40, a password previously entered by the user using the HMI 43, a telephone number and the like when the portable terminal 40 has a verbal communication function.

The control section 27 of the in-vehicle apparatus 20 receives the type information and the portable terminal specific information from the portable terminal 40. Based on the type information, the control section 27 specifies a communication destination type such as the portable terminal 40, the setup card 92, or the activation card 93. In addition, the control section 27 determines whether or not the storage section 26 stores the same portable terminal specific information as the received one (S104). Based on the results, the control section 27 determines a subsequent process. The description assumes the following. The communication destination type is specified as the portable terminal 40. The storage section 26 does not store the same portable terminal specific information as the received one. The subsequent process is determined to “receive a command request from the portable terminal 40.” When the storage section 26 stores the same portable terminal specific information as the received one, the control section 27 enables the active state for the in-vehicle apparatus card information corresponding to the portable terminal specific information.

The control section 27 of the in-vehicle apparatus 20 transmits a command request to the portable terminal 40 via the contactless communication interface 25 (S105).

After receiving the command request, the control section 47 of the portable terminal 40 transmits a command to register the in-vehicle apparatus card information to the in-vehicle apparatus 20 and a command to request the in-vehicle apparatus specific information to the in-vehicle apparatus 20 via the contactless communication interface 45 (S106). For example, the “in-vehicle apparatus specific information” represents a management number, type registration number, vehicle number, and the like.

After receiving the command, the control section 27 of the in-vehicle apparatus 20 transmits in-vehicle apparatus specific information to the portable terminal 40 via the contactless communication interface 25 (S110).

After receiving the in-vehicle apparatus specific information, the control section 47 of the portable terminal 40 stores the received in-vehicle apparatus specific information in the ETC area of the storage section 46. In addition, the control section 47 requests in-vehicle apparatus card information from the card center server 80 via the wireless antenna 41 and the public communication section 42 (S115). The information transmitted to the card center server 80 includes not only the information indicating the request but also the in-vehicle apparatus specific information stored in the ETC area of the storage section 46 and the portable terminal card information already stored in the storage section 46. Incidentally, the “portable terminal card information” signifies card information used for the portable terminal 40 to perform a charging process. When a user of the portable terminal 40 places the portable terminal 40 over a special terminal at a convenience store, a restaurant, and the like, the special terminal reads the portable terminal card information to perform the charging process.

The card center server 80 receives the request for the in-vehicle apparatus card information and the like from the portable terminal 40 and determines whether or not the received portable terminal card information is valid (S120). Specifically, the card center server 80 references a database for storing data concerning the portable terminal card information to determine whether or not the portable terminal card information is officially issued card information. When the portable terminal card information is determined to be valid, the card center server 80 generates in-vehicle apparatus card information (S125). The in-vehicle apparatus card information is scheduled to be stored in the in-vehicle apparatus 20 and is read from the in-vehicle apparatus 20 when needed so as to be used for the charging process.

After generating the in-vehicle apparatus card information, the card center server 80 transmits the generated in-vehicle apparatus card information to the portable terminal 40 (S130).

After receiving the in-vehicle apparatus card information, the control section 47 of the portable terminal 40 transmits the received in-vehicle apparatus card information and the portable terminal specific information stored in the storage section 26 to the in-vehicle apparatus 20 via the contactless communication interface 25 (S140). Incidentally, the “portable terminal specific information” is information specific to the portable terminal 40. Specifically, for example, the portable terminal specific information may represent a hardware-specific ID of the portable terminal 40, a password previously entered by the user using the HMI 43, a telephone number and the like when the portable terminal 40 has a verbal communication function. Further, the portable terminal specific information may represent information generated based on the portable terminal card information already stored in the storage section 26.

After receiving the in-vehicle apparatus card information and the portable terminal specific information, the control section 27 of the in-vehicle apparatus 20 accepts input of a private code from the user via the HMI 23 (S145). The private code may represent a number containing the specified number of digits, a sequence of pressing operation buttons, and the like. Incidentally, it is preferable to cancel input of the private code based on a user operation. Cancellation of the input makes it possible to provide an option to disable activation of the in-vehicle apparatus card information in accordance with input of the private code.

Subsequently, the control section 27 of the in-vehicle apparatus 20 allows the storage section 26 to store the in-vehicle apparatus card information and the portable terminal specific information received from the portable terminal 40 and the private code entered by the user (S150). Incidentally, the storage section 26 stores the in-vehicle apparatus card information in the inactive state. Thereafter, the control section 27 of the in-vehicle apparatus 20 transmits a notification (registration completion notification) indicating completion of the storage to the portable terminal 40 via the contactless communication interface 256 (S155).

After receiving the registration completion notification, the control section 47 of the portable terminal 40 allows the HMI 43 (specifically a liquid crystal panel) to display a content indicating that the in-vehicle apparatus card information has been registered to the in-vehicle apparatus 20 (S160). Then, the control section 47 of the portable terminal 40 transmits the registration completion notification to the card center server 80 via the wireless antenna 41 and the communication section 42 (S165). After receiving the registration completion notification, the card center server 80 records the in-vehicle apparatus card information generated at S125 as valid information.

(4) Method 2 of Registering the in-Vehicle Apparatus Card Information

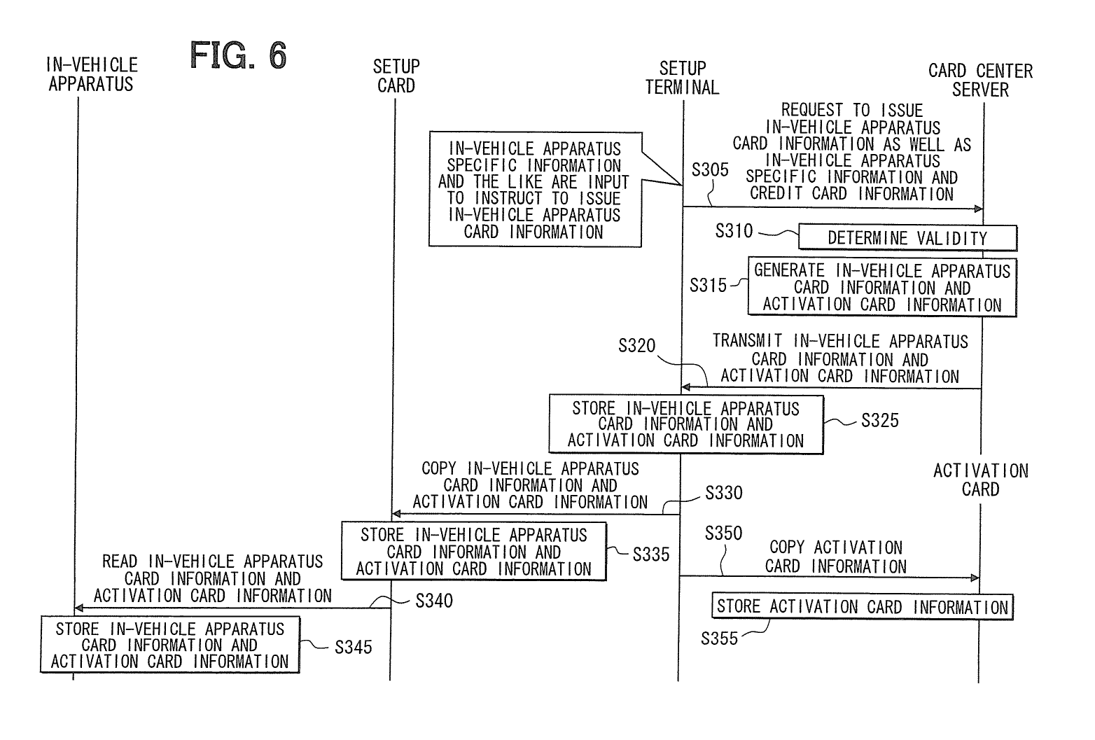

Then, with reference to a flow chart in FIG. 6, the following describes a process in which a salesperson at a shop, a vehicle sales dealer, or the like for the in-vehicle apparatus 20 registers the in-vehicle apparatus card information to the in-vehicle apparatus 20.

Let us suppose that a salesperson uses the setup terminal 91 to enter the in-vehicle apparatus specific information (a management number, type registration number, vehicle number, and the like) and credit card information and to enter an instruction to issue the in-vehicle apparatus card information. The setup terminal 91 transmits the request to issue the in-vehicle apparatus card information as well as the entered in-vehicle apparatus specific information and credit card information to the card center server 80 (S305).

After receiving the request to issue the in-vehicle apparatus card information, the card center server 80 determines whether or not the received credit card information is valid (S310). Specifically, the card center server 80 references a database for storing data concerning the credit card information to determine whether or not the credit card information is officially issued card information. When the credit card information is determined to be valid, the card center server 80 generates in-vehicle apparatus card information and activation card information (S315). The in-vehicle apparatus card information is scheduled to be stored in the in-vehicle apparatus 20 and is read from the in-vehicle apparatus 20 when needed so as to be used for the charging process. Further, the activation card information is scheduled to be stored in the activation card 93 and is used to activate the in-vehicle apparatus card information stored in the in-vehicle apparatus 20.

After generating the in-vehicle apparatus card information and the activation card information, the card center server 80 transmits the generated information to the setup terminal 91 (S320).

After receiving the in-vehicle apparatus card information and the activation card information, the setup terminal 91 temporarily stores the received information in an internal storage section (S325). Let us suppose that the salesperson at a shop, a vehicle sales dealer, or the like places the setup card 92 near the setup terminal 91 and performs operations on the setup terminal 91 so as to copy and store the in-vehicle apparatus card information and the activation card information in the setup card 92. The in-vehicle apparatus card information and the activation card information stored in the setup terminal 91 are copied and stored in the setup card 92 via the near field communication (S330).

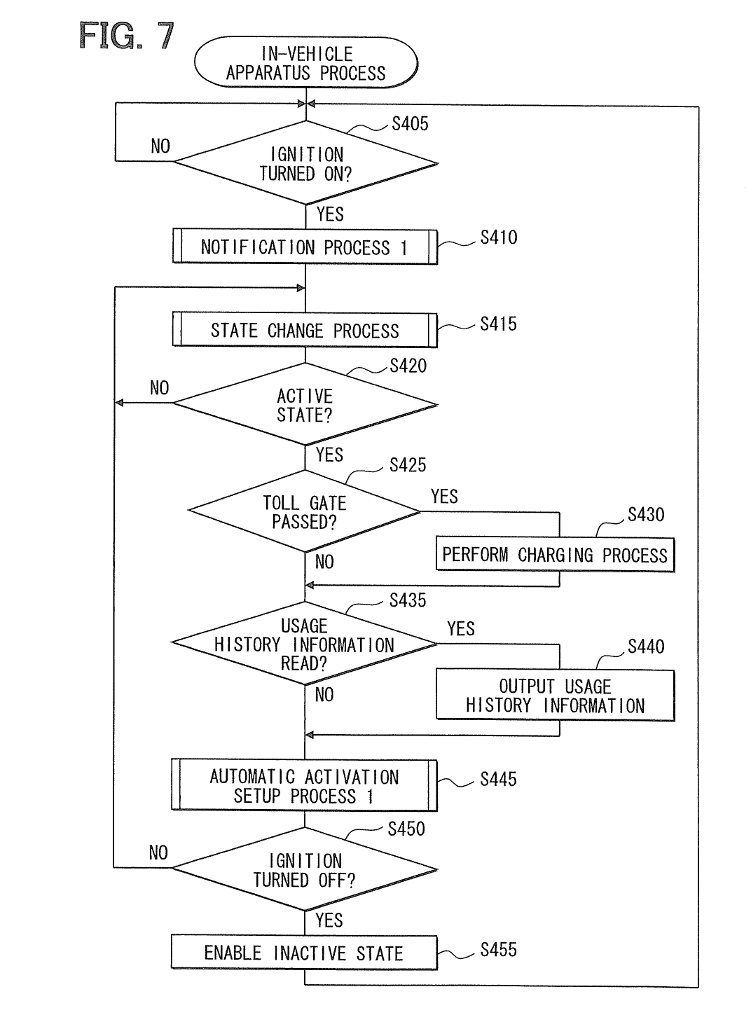

Let us suppose that the setup card 92 receives the in-vehicle apparatus card information and the activation card information and the salesperson places the setup card 92 near a range capable of the near field communication for the in-vehicle apparatus 20. The in-vehicle apparatus card information and the activation card information stored in the setup card 92 are read to the in-vehicle apparatus 20 via the contactless communication interface 25 of the in-vehicle apparatus 20 and are stored in the storage section 26 of the in-vehicle apparatus 20 (S340 and S345). Incidentally, the response request at S101 or S102 in FIG. 5 is omitted from FIG. 7. Actually, the in-vehicle apparatus 20 makes a similar, response request. The setup card 92 responds to the request to transmit the information indicating the setup card to the in-vehicle apparatus 20. Thereafter, the control section 27 of the in-vehicle apparatus 20 specifies the type of the communication party based on the received type information and reads the in-vehicle apparatus card information and the activation card information from the setup card 92.

In addition, when the salesperson places the activation card 93 near a range capable of the near field communication for the setup terminal 91, the activation card information stored in the setup terminal 91 is copied and stored in the activation card 93 (S350 and S355).

(5) In-Vehicle Apparatus Process

With reference to a flow chart in FIG. 7, the following then describes the in-vehicle apparatus process executed by the control section 27 of the in-vehicle apparatus 20. The above described in-vehicle apparatus process is continuously executed while an in-vehicle battery supplies constantly supplied power (so-called +B) to the in-vehicle apparatus 20. The control section 27 of the in-vehicle apparatus 20 starts executing the in-vehicle apparatus process and determines whether or not an ignition switch changes the state from “off” to “on” (S405). The determination is based on a signal from a sensor that outputs the ignition switch state. As a result, when it is determined that the ignition switch state changes from “off” to “on” (Yes at S405), the process proceeds to S410. When it is determined that the ignition switch state does not change from “off” to “on” (No at S405), the process remains at S405.

The process proceeds to S410 when the ignition switch state changes from “off” to “on.” At S410, the control section 27 of the in-vehicle apparatus 20 executes a notification process 1. Details of the notification process 1 will be described later.

The control section 27 of the in-vehicle apparatus 20 then executes a state change process (S415). Details of the state change process will be described later.

The control section 27 of the in-vehicle apparatus 20 then determines whether or not the in-vehicle apparatus card information stored in the storage section 26 is placed in the active state (S420). When it is determined that the active state is enabled (Yes at S420), the process proceeds to S425. When it is determined that the active state is not enabled, namely, the inactive state is enabled, the process returns to S415.

The control section 27 of the in-vehicle apparatus 20 then determines whether or not to detect the timing at which the vehicle mounted with the in-vehicle apparatus 20 passes through the toll gate of a toll road (S425). The process proceeds to S430 when determining the timing to pass through the toll gate of the toll road (Yes at S425). The process proceeds to S435 when determining the timing not to pass through the toll gate of the toll road (No at S425).

The process proceeds to S430 when determining the timing to pass through the toll gate of the toll road. At S430, the control section 27 of the in-vehicle apparatus 20 uses the in-vehicle apparatus card information in the active state, communicates with the roadside apparatus 30 via the DSRC section 22 and the wireless antenna 21, and executes the charging process (an entrance charging process at a tollbooth entrance or an exit charging process at tollbooth exit). A conventional charging process uses card information read from an ETC card. The charging process according to the embodiment differs from the conventional charging process in that the charging process uses the in-vehicle apparatus card information stored in the storage section 26 instead of the card information read from the ETC card. In terms of the other points, the charging process according to the embodiment is similar to the conventional charging process. Incidentally, when the charging process is performed at the tollbooth exit, the storage section 26 stores information about charging contents as usage history information. Upon termination of the charging process, the control section 27 of the in-vehicle apparatus 20 advances the process to S435.

At S435, the control section 27 of the in-vehicle apparatus 20 determines whether or not to detect the timing to receive a usage history information reading command. The usage history information reading command is equivalent to an instruction to notify usage history of the in-vehicle apparatus 20 by the user via the HMI 23 (specifically an operation button), an instruction to notify usage history of the navigation system by the user, an instruction issued when the portable terminal 40 is placed near the in-vehicle apparatus, and the like. The process proceeds to S440 when determining the timing to receive the usage history information reading command (Yes at S435). The process proceeds to S445 when determining the timing not to receive the usage history information reading command (No at S435).

The process proceeds to S440 when determining the timing to receive the usage history information reading command. At S440, the control section 27 reads the usage history information from the storage section 26 and outputs the same. Specifically, the control section 27 may receive a command from the user of the in-vehicle apparatus 20 via the HMI 23 (specifically an operation button). In such a case, the control section 27 audibly outputs the past usage history through the HMI 23 (specifically an speaker) based on the read usage history information. Further, the control section 27 may receive a command from the user or the like via another apparatus (e.g., a navigation system). In such a case, the control section 27 transmits the read usage history information to the other apparatus. Moreover, when the portable terminal 40 is placed near the in-vehicle apparatus 20, the control section 27 transmits the usage history information to the portable terminal 40 via the contactless communication interface 25 of the in-vehicle apparatus 20. When terminating output of the usage history information, the control section 27 of the in-vehicle apparatus 20 advances the process to S445.

At S445, the control section 27 of the in-vehicle apparatus 20 executes an automatic activation setup process 1. Details of the automatic activation setup process 1 will be described later.

The control section 27 of the in-vehicle apparatus 20 then determines whether or not the ignition switch state changes from “on” to “off” (S450). The determination is based on a signal from a sensor that outputs the ignition switch state. As a result, when it is determined that the ignition switch state changes from “on” to “off” (Yes at S450), the process proceeds to S455. When it is determined that the ignition switch state does not change from “on” to “off” (No at S450), the process returns to S415.

The process proceeds to S455 when the ignition switch state changes from “on” to “off.” At S455, the control section 27 changes the active state of the in-vehicle apparatus card information stored in the storage section 26 to the inactive state. The process returns to S405.

(6) State Change Process

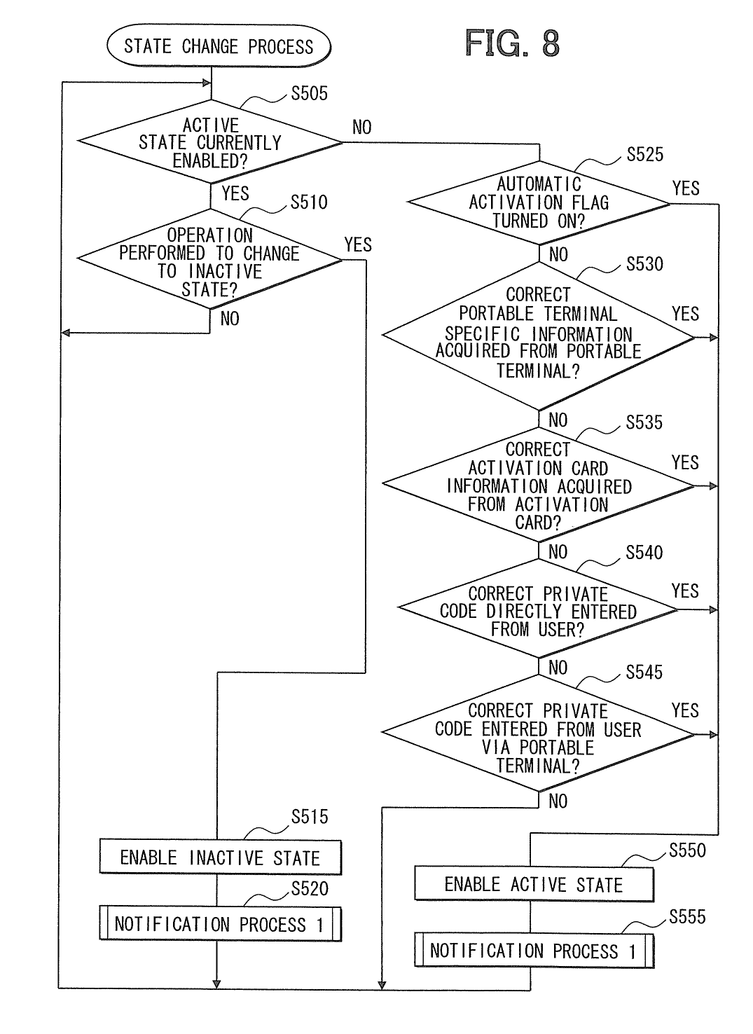

Next, with reference to a flow chart in FIG. 8, the following describes the state change process executed by the control section 27 of the in-vehicle apparatus 20. The state change process is called at S415 of the above-mentioned in-vehicle apparatus process and starts executing.

When starting execution of the state change process, the control section 27 of the in-vehicle apparatus 20 determines whether or not the active state is enabled for the in-vehicle apparatus card information stored in the storage section 26 (S505). The “active state” signifies a state capable of reading the in-vehicle apparatus card information stored in the storage section 26. The active state is determined by the state of an active state flag provided for the storage section 26. Specifically, the “on” state of the active state flag corresponds to the active state. The “off” state of the active state flag corresponds to the inactive state. The inactive state prevents reading of the in-vehicle apparatus card information stored in the storage section 26. An appropriate lock function is provided.

When it is determined at S505 that the current state is the active state (Yes at S505), the process proceeds to S510. When it is determined that the current state is not the active state (No at S505), the process proceeds to S525.

The process proceeds to S510 when it is determined at S505 that the current state is the active state. At S510, the control section 27 determines whether or not the user uses the HMI 23 (specifically an operation button) of the in-vehicle apparatus 20 to perform an operation signifying a change from the active state to the inactive state. Incidentally, the determination may use an input to an operation section or the like of the navigation system connected to the in-vehicle apparatus 20 instead of an input to the HMI 23 of the in-vehicle apparatus 20. The process proceeds to S515 when it is determined that the user performs an operation signifying a change from the active state to the inactive state (Yes at S510). On the other hand, the process returns to S505 when it is determined that the user performs an operation signifying a change from the active state to the inactive state (No at S510).

The process proceeds to S515 when it is determined that the user performs an operation signifying a change from the active, state to the inactive state. At S515, the control section 27 changes the state of the active state flag provided for the storage section from “on” to “off” and executes a notification process 1. Details of the notification process 1 will be described later. When the notification process 1 terminates, the process returns to S505.

On the other hand, the process proceeds to S525 when it is determined that the current state is not the active state. At S525, the control section 27 determines whether or not the state of the automatic activation flag provided for the storage section 26 is “on.” The “automatic activation flag” indicates whether or not to always enable the active state (automatic active state) for the in-vehicle apparatus card information once activated by the user except while the ignition switch state is “off.” The process proceeds to S550 when the automatic activation flag state is “on” (Yes at S525). The process proceeds to S530 when the automatic activation flag state is “off” (No at S525).

The process proceeds to S530 when it is determined that the automatic activation flag state is “off.” At S530, the control section 27 determines whether or not to acquire correct portable terminal specific information from the portable terminal 40 via the contactless communication interface 25. The determination is performed based on the result of an interaction similar to the one at S101 through S103 above between the in-vehicle apparatus 20 and the portable terminal 40. Further, the determination of “successful acquisition of the correct portable terminal specific information” applies to a case where the portable terminal specific information acquired from the portable terminal 40 is the same as the portable terminal specific information stored in the storage section 26 of the in-vehicle apparatus 20. As a result, the process proceeds to S550 when it is determined that the correct portable terminal specific information is acquired from the portable terminal 40 (Yes at S530). The process proceeds to S535 when it is determined that the correct portable terminal specific information is not acquired from the portable terminal 40 (No at S530).

The process proceeds to S535 when it is determined that the correct portable terminal specific information is not acquired from the portable terminal 40. At S535, the control section 27 determines whether or not to acquire the correct activation card information from the activation card 93 via the contactless communication interface 25. The determination is performed based on the result of an interaction similar to the one at S101 through S103 above between the in-vehicle apparatus 20 and the activation card 93. Further, the determination of “successful acquisition of the correct activation card information” applies to a case where the activation card information acquired from the activation card 93 is the same as the activation card information stored in the storage section 26 of the in-vehicle apparatus 20. As a result, the process proceeds to S550 when it is determined that the correct activation card information is acquired from the activation card 93 (Yes at S535). The process proceeds to S540 when it is determined that the correct activation card information is not acquired from the activation card 93 (No at S535).

The process proceeds to S540 when it is determined that the correct activation card information is not acquired from the activation card 93. At S540, the control section 27 determines whether or not the user directly enters a correct private code from the HMI 23 of the in-vehicle apparatus 20. In the present context, the “correct private code” signifies a private code that is already entered by the user to the in-vehicle apparatus 20 and is stored in the storage section 26 (see S145).

The process proceeds to S550 when it is determined at S540 that the user directly enters the correct private code (Yes at S540). The process proceeds to S545 when it is determined that the user does not directly enter the correct private code or enters nothing at all (No at S540).

The process proceeds to S545 when it is determined that the user does not directly enter the correct private code. At S545, the control section 27 determines whether or not to acquire a correct private code from the portable terminal 40. In the present context, the “correct private code” signifies a private code that is already registered by the user to the in-vehicle apparatus 20 and is stored in the storage section 26 (see S145). Incidentally, the private code transmitted from the portable terminal 40 was entered by the user to the portable terminal 40. The control section 27 advances the process to S550 when it is determined that the correct private code is acquired from the portable terminal 40 (Yes at S545). The control section 27 returns the process to S505 when it is determined that the correct private code is not acquired from the portable terminal 40 (No at S545).

At S550, the control section 27 changes the state of the active state flag provided for the storage section 26 from “off” to “on” and executes the notification process 1. Details of notification process 1 will be described later. When the notification process 1 terminates, the control section 27 returns the process to S505.

(7) Automatic Activation Setup Process 1

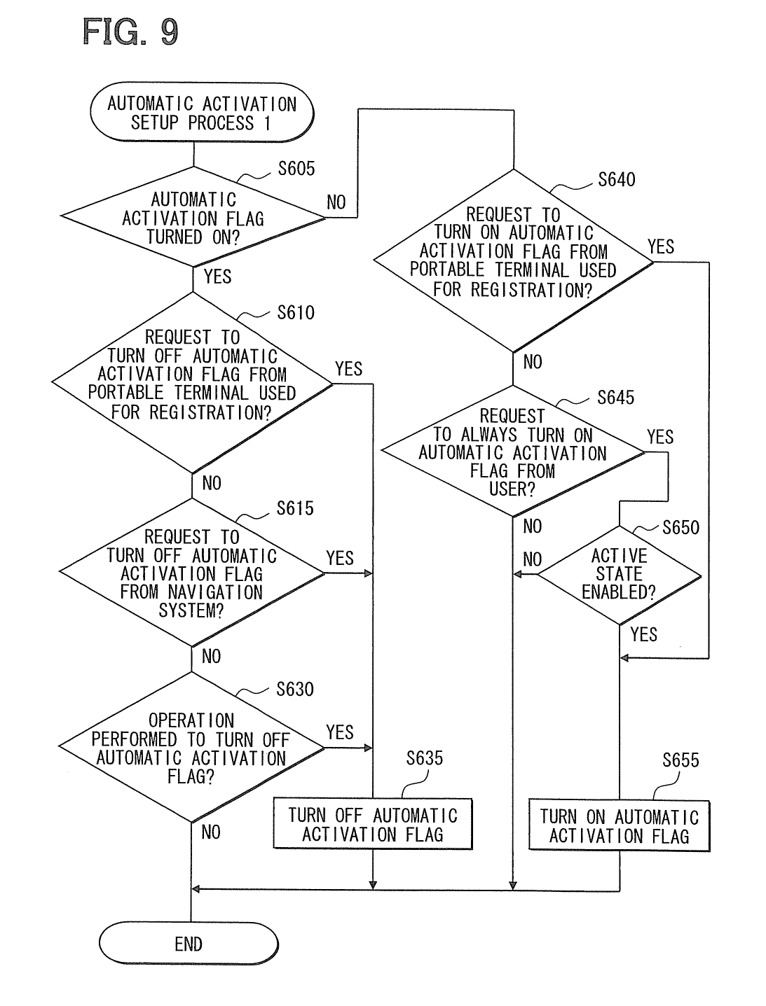

Next, with reference to a flow chart in FIG. 9, the following describes the automatic activation setup process 1 executed by the control section 27 of the in-vehicle apparatus 20. Incidentally, The automatic activation setup process 1 is called at S445 of the above-mentioned in-vehicle apparatus process and starts executing.

The control section 27 of the in-vehicle apparatus 20 starts executing the automatic activation setup process 1 to determine whether or not the automatic activation flag provided for the storage section 26 is turned “on” (S605). The process proceeds to S610 when it is determined that the automatic activation flag is turned “on” (Yes at S605). The process proceeds to S640 when it is determined that the automatic activation flag is not turned “on” (No at S605).

The process proceeds to S610 when it is determined that the automatic activation flag provided for the storage section 26 is turned “on.” At S610, the control section 27 determines whether or not the portable terminal 40 used for registering the in-vehicle apparatus card information stored in the storage section 26 issues a request to turn “off” the automatic activation flag. The determination is performed based on the result of an interaction similar to the one at S101 through S103 above between the in-vehicle apparatus 20 and the portable terminal 40. It is obvious to determine no request when there is no communication between the in-vehicle apparatus 20 and the portable terminal 40 at all. As a result of the determination, the process proceeds to S635 when it is determined that the portable terminal 40 used for registering the in-vehicle apparatus card information issues a request to turn “off” the automatic activation flag (Yes at S610). The process proceeds to S615 when it is determined that the portable terminal 40 used for registering the in-vehicle apparatus card information does not issue a request to turn “off” the automatic activation flag (No at S610).

The process proceeds to S615 when it is determined that the portable terminal 40 used for registering the in-vehicle apparatus card information does not issue a request to turn “off” the automatic activation flag. At S615, the control section 27 determines whether or not the navigation system issues a request to turn “off” the automatic activation flag. The process proceeds to S635 when it is determined that the navigation system issues a request to turn “off” the automatic activation flag (Yes at S615). The process proceeds to S630 when it is determined that the navigation system does not issue a request to turn “off” the automatic activation flag (No at S615).

The process proceeds to S630 when it is determined that the navigation system does not issue a request to turn “off” the automatic activation flag. At S630, the control section 27 determines whether or not the user performs an operation to change the automatic activation flag to the “off” state using the HMI 23 (specifically an operation button). Incidentally, the operation button may be a special operation button. For example, it may be preferable to determine that the user requests to turn “off” the automatic activation flag when a volume switch and a usage history notification switch are simultaneously pressed for a long time. The process proceeds to S635 when it is determined that the user performs an operation to turn “off” the automatic activation flag (Yes at S630). The process (automatic activation setup process 1) terminates when it is determined that the user does not perform an operation to turn “off” the automatic activation flag (No at S630).

At S635, the control section 27 changes the state of the automatic activation flag provided for the storage section 26 from “on” to “off” and then terminates the process (automatic activation setup process 1).

The process proceeds to S640 when it is determined that the automatic activation flag is not turned “on.” At S640, the control section 27 determines whether or not the portable terminal 40 used for registering the in-vehicle apparatus card information stored in storage section 26 issues a request to turn “on” the automatic activation flag. The determination is performed based on the result of an interaction similar to the one at S101 through S103 above between the in-vehicle apparatus 20 and the portable terminal 40. It is obvious to determine no request when there is no communication between the in-vehicle apparatus 20 and the portable terminal 40 at all. As a result of the determination, the process proceeds to S655 when it is determined that the portable terminal 40 used for registering the in-vehicle apparatus card information issues a request to turn “on” the automatic activation flag (Yes at S640). The process proceeds to S645 when it is determined that the portable terminal 40 used for registering the in-vehicle apparatus card information does not issue a request to turn “on” the automatic activation flag (No at S640).

The process proceeds to S645 when it is determined that the portable terminal 40 used for registering the in-vehicle apparatus card information does not issue a request to turn “on” the automatic activation flag. At S645, the control section 27 determines whether or not the user issues a request to turn “on” the automatic activation flag. Specifically, the control section 27 determines whether or not the user performs an operation indicating a request to turn “on” the automatic activation flag using the HMI 23 (specifically an operation button) or the navigation system. Incidentally, the operation button may be a special operation button. For example, it may be preferable to determine that the user requests to turn “on” the automatic activation flag when the volume switch and the usage history notification switch are simultaneously pressed for a long time. The process proceeds to S650 when it is determined that the user performs an operation to turn “on” the automatic activation flag (Yes at S645). The process (automatic activation setup process 1) terminates when it is determined that the user does not perform an operation to turn “on” the automatic activation flag (No at S645).

The process proceeds to S650 when it is determined that the user performs an operation to turn “on” the automatic activation flag. At S650, the control section 27 determines whether or not the in-vehicle apparatus card information stored in the storage section 26 is set to the active state. The process proceeds to S655 when it is determined that the in-vehicle apparatus card information is set to the active state (Yes at S650). The process (automatic activation setup process 1) terminates when it is determined that the in-vehicle apparatus card information is not set to the active state (No at S650).

At S655, the control section 27 changes the state of the automatic activation flag provided for the storage section 26 from “off” to “on” and then terminates the process (automatic activation setup process 1).

(8) Automatic Activation Setup Process 2

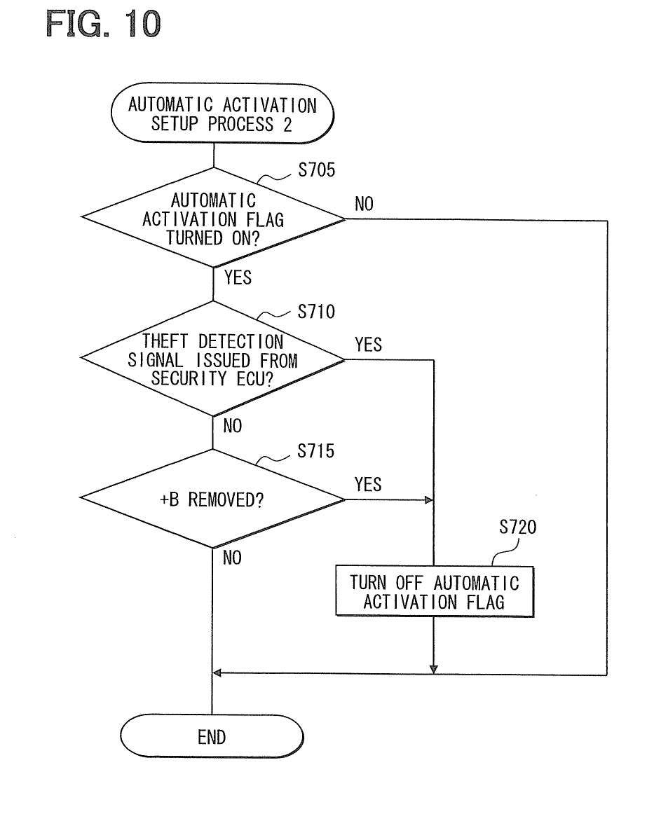

Next, with reference to a flow chart in FIG. 10, the following describes the automatic activation setup process 2 executed by the control section 27 of the in-vehicle apparatus 20. Incidentally, the automatic activation setup process 2 is repeatedly executed at a specified interval such as an interval of ten seconds, for example.

The control section 27 of the in-vehicle apparatus 20 starts executing the automatic activation setup process 2 to determine whether or not the automatic activation flag provided for the storage section 26 is turned “on” (S705). The process proceeds to S710 when it is determined that the automatic activation flag is turned “on” (Yes at S705). The process (automatic activation setup process 2) terminates when it is determined that the automatic activation flag is not turned “on” (No at S705).

The process proceeds to S710 when it is determined that the automatic activation flag is turned “on.” At S710, the control section 27 determines whether or not the security ECU issues a theft detection signal. The process proceeds to S720 when it is determined that the security ECU issues a theft detection signal (Yes at S710). The process proceeds to S715 when it is determined that the security ECU does not issue a theft detection signal (No at S710).

The process proceeds to S715 when it is determined that the security ECU does not issue a theft detection signal. At S715, the control section 27 determines whether or not constantly supplied power (so-called +B) is removed from the in-vehicle battery. The process proceeds to S720 when it is determined that +B is removed and is not supplied (Yes at S625). The process (automatic activation setup process 2) terminates when it is determined that +B is not removed and is supplied (No at S625).

At S720, the control section 27 changes the state of the automatic activation flag provided for the storage section 26 from “on” to “off” and then terminates the process (automatic activation setup process 2).

(9) In-Vehicle Apparatus Card Information

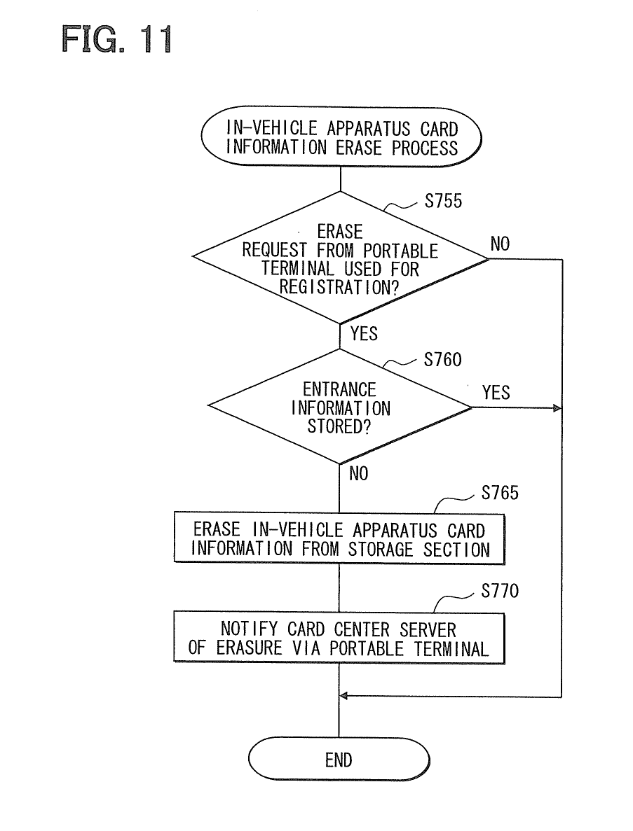

Next, with reference to a flow chart in FIG. 11, the following describes the in-vehicle apparatus card information erasure process executed by the control section 27 of the in-vehicle apparatus 20. The control section 27 starts executing the in-vehicle apparatus card information erasure process when receiving a command to erase the in-vehicle apparatus card information from the user of the in-vehicle apparatus 20 via the HMI 23.

The control section 27 of the in-vehicle apparatus 20 starts executing the in-vehicle apparatus card information erasure process to determine whether or not there is a request to erase the in-vehicle apparatus card information from the portable terminal 40 used for registering the in-vehicle apparatus card information stored in the storage section 26 (S755). The determination is performed based on the result of an interaction similar to the one at S101 through S103 above between the in-vehicle apparatus 20 and the portable terminal 40. It is self-evident to determine that no request has been made when there is no communication between the in-vehicle apparatus 20 and the portable terminal 40. As a result of the determination, the process proceeds to S760 when it is determined that the portable terminal 40 used for registering the in-vehicle apparatus card information stored in the storage section 26 issues a request to erase the in-vehicle apparatus card information (Yes at S755). The process (in-vehicle apparatus card information erasure process) terminates when it is determined that the portable terminal 40 used for registering the in-vehicle apparatus card information stored in the storage section 26 does not issue a request to erase the in-vehicle apparatus card information (No at S755).

The process proceeds to S760 when it is determined that the portable terminal 40 used for registering the in-vehicle apparatus card information stored in the storage section 26 issues a request to erase the in-vehicle apparatus card information. At S760, the control section 27 determines whether or not the storage section 26 stores entrance information. The “entrance information” indicates from which entrance tollbooth the vehicle enters the toll road. When the vehicle passes through the entrance tollbooth, the charging process (entrance charging process) is executed to store the entrance information in the storage section 26. When the vehicle passes through the exit tollbooth, the charging process (exit charging process) is executed to erase the entrance information from the storage section 26. The determination is applied to the entrance information stored when the charging process is executed using the in-vehicle apparatus specific information corresponding to the portable terminal specific information acquired from the portable terminal 40 that issued the erase request. The process (in-vehicle apparatus card information erasure process) terminates when it is determined that the storage section 26 stores the entrance information (Yes at S760). The process proceeds to S765 when it is determined that the storage section 26 does not store the entrance information (No at S760).

The process proceeds to S765 when it is determined that the storage section 26 does not store the entrance information. At S765, the control section 27 erases the in-vehicle apparatus card information from the storage section 26. The control section 27 then notifies the erasure to the card center server 80 via the portable terminal 40 by specifying the erased in-vehicle apparatus card information (S770). Finally, the control section 27 terminates the process (in-vehicle apparatus card information erasure process).

(10) Notification Process 1

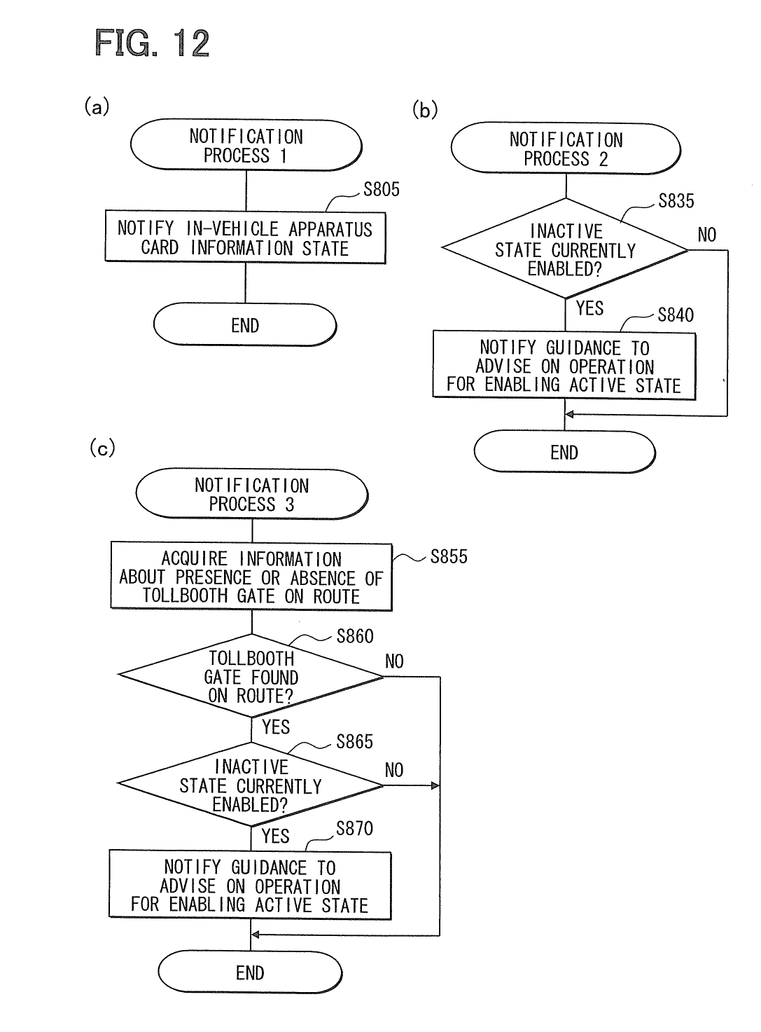

Next, with reference to a flow chart in FIG. 12 part (a), the following describes the notification process 1 executed by the control section 27 of the in-vehicle apparatus 20. The notification process 1 starts execution when called at S410 of the in-vehicle apparatus process, S515 and S550 of the state change process, and the like mentioned above.

The control section 27 of the in-vehicle apparatus 20 starts executing the notification process 1 to notify the user of an in-vehicle apparatus card information state (S805). The “in-vehicle apparatus card information state” signifies the state of the active state flag provided for the storage section 26 of the in-vehicle apparatus 20. Specifically, the notification is made by using the HMI 23 (specifically a speaker) to output an audio such as “the in-vehicle apparatus card information is currently available” when the active state flag state is turned “on.” Further, the notification is made by using the HMI 23 (specifically a speaker) to output an audio such as “the in-vehicle apparatus card information is currently unavailable” when the active state flag state is turned “off.”

After providing the notification, the control section 27 terminates the process (notification process 1).

### Effect of the Embodiment

The in-vehicle apparatus 20 is configured to change the state of the active state flag provided for the storage section 26 from “on” to “off” (S455 and S515) when the ignition switch changes from “on” to “off” (Yes at S450) and when the user performs an operation signifying the change from the active state to the inactive state (Yes at S510). When the active state flag state changes from “on” to “off,” the in-vehicle apparatus card information stored in the storage section 26 changes the active state to the inactive state. The in-vehicle apparatus card information is prevented from being read from the storage section 26. Accordingly, the in-vehicle apparatus card information is disabled by an explicit user operation or a normal operation performed when the user gets out of the vehicle. It is possible to prevent the unauthorized use of the in-vehicle apparatus card information when the user does not get in the vehicle.

Further, when the user enters a correct private code from the HMI 23 of the in-vehicle apparatus 20 (Yes at S540), the active state flag provided for the storage section 26 is configured to change the state from “off” to “on” (S550). When the active state flag state changes from “off” to “on,” the in-vehicle apparatus card information stored in the storage section 26 changes the inactive state to the active state. The in-vehicle apparatus card information can be read from the storage section 26. Therefore, since the private code can be managed secretly, only a person that knows the private code can perform the charging process by using the in-vehicle apparatus card information while preventing the unauthorized use of the in-vehicle apparatus card information when the user leaves the vehicle.

Further, the control section 27 is configured to change the state of the active state flag provided for the storage section 26 from “off” to “on” (S550) also when a correct private code is entered from the portable terminal (Yes at S545). When the active state flag state changes from “off” to “on,” the in-vehicle apparatus card information stored in the storage section 26 changes from the inactive state to the active state. The in-vehicle apparatus card information can be read from the storage section 26. Therefore, only a person that owns the portable terminal 40 storing the correct private code can perform the charging process using the in-vehicle apparatus card information while preventing the unauthorized use of the in-vehicle apparatus card information when the user leaves the vehicle.

Further, the control section 27 is configured to provide a notification of the state of the in-vehicle apparatus card information (Yes at S405 and S410) when a driver performs an operation (e.g., ignition key operation) needed for vehicle running. Therefore, the user can notice the state of the in-vehicle apparatus card information when performing the relevant operation. It is thereby possible to avoid forgetting to set the in-vehicle apparatus card information to the active state although it is necessary to do so. In other words, it is possible to prevent occurrence of a trouble of being obliged to stop at the tollbooth.

Further, the control section 27 is configured to change the active state flag state from “off” to “on” (S550) when the ignition switch is turned “on” (Yes at S405) and the automatic activation flag state is “on” (Yes at S525). For the above described reason, the in-vehicle apparatus card information is set to the active state even though the user does not explicitly perform an operation to set the in-vehicle apparatus card information to the active state. It is thereby possible to reduce a trouble of performing an operation to set the in-vehicle apparatus card information to the active state.

### Other Embodiments

(1) Notification Process 2

The control section 27 of the in-vehicle apparatus 20 may perform a notification process 2. With reference to a flow chart in FIG. 12 part (b), the following describes the notification process 2. Incidentally, execution of the notification process 2 starts when the driver performs a specified operation needed for vehicle running. The “specified operation needed for vehicle running” signifies an ignition key operation, an operation to set a destination on the navigation system, and the like, for example.

The control section 27 of the in-vehicle apparatus 20 starts executing the notification process 2 to determine whether or not the in-vehicle apparatus card information is currently set to the inactive state (S835). The determination uses the active state flag provided for the storage section 26. The control section 27 advances the process to S840 when the in-vehicle apparatus card information is currently set to the inactive state (Yes at S835). The control section 27 terminates the process (notification process 2) when the in-vehicle apparatus card information is currently set to the active state (No at S835).

The control section 27 advances the process to S840 when the in-vehicle apparatus card information is currently set to the inactive state. At S840, the control section 27 notifies the user of guidance to advise on an operation for setting the in-vehicle apparatus card information to the active state. Specifically, the notification is performed by using the HMI 23 (specifically a speaker) to audibly output a message such as “The in-vehicle apparatus card information is currently unavailable. Enter the private code on the operation section, or place the portable terminal over the portable terminal.”

After performing the notification, the control section 27 terminates the process (notification process 2).

When the control section 27 is configured to execute the notification process 2 as mentioned above, the control section 27 advises the user to perform an operation for setting the in-vehicle apparatus card information to the active state only when the notification is very likely to be needed. It is possible to reduce annoyance the user may feel as to the notification.

(2) Notification Process 3

The control section 27 of the in-vehicle apparatus 20 may perform a notification process 3 when receiving the notification indicating that the navigation system starts route guidance. The following describes the notification process 3 with reference to a flow chart in FIG. 12(c).

The control section 27 of the in-vehicle apparatus 20 starts executing the notification process 3 to acquire information indicating whether or not the tollbooth gate of the toll road is located on the route (S855). The control section 27 then branches the process according to the acquired information (S860). Specifically, the control section 27 advances the process to S865 when the tollbooth gate of the toll road is located on the route. The control section 27 terminates the process (notification process 3) when the tollbooth gate of the toll road is not located on the route.

The process proceeds to S865 when the tollbooth gate of the toll road is located on the route. At S865, the control section 27 determines whether or not the in-vehicle apparatus card information is currently set to the inactive state. The control section 27 advances the process to S870 when it is determined that the in-vehicle apparatus card information is currently set to the inactive state (Yes at S865). The control section 27 terminates the process (notification process 3) when it is determined that the in-vehicle apparatus card information is currently not set to the inactive state (No at S865).

The process proceeds to S870 when it is determined that the in-vehicle apparatus card information is currently set to the inactive state. The control section 27 notifies the user of guidance to advise on an operation for setting the in-vehicle apparatus card information to the active state. Specifically, the notification is performed by using the HMI 23 (specifically a speaker) to audibly output a message such as “The in-vehicle apparatus card information is currently unavailable. Enter the private code on the operation section, or place the portable terminal over the portable terminal.” After performing the notification, the control section 27 terminates the process (notification process 3).

When the control section 27 is configured to execute the notification process 3 as mentioned above, the control section 27 does not provide notification (unnecessary notification) for advising the user to perform an operation for setting the in-vehicle apparatus card information to the active state even though the in-vehicle apparatus card information is not used. It is possible to reduce annoyance the user may feel as to the notification.

(3) The above-mentioned embodiment is applied to the toll fare but may be applied to a payment other than the toll fare. For example, the embodiment may be applied to a gasoline cost, parking fee, fast food payment, and the like. Even when the charging process is applied to these, the same effects as the above-mentioned embodiment can be provided.

(4) While the above-mentioned embodiment has described the case of storing only one piece of in-vehicle apparatus card information in the storage section 26 of the in-vehicle apparatus 20, multiple elements of in-vehicle apparatus card information may be stored. There may be techniques of storing multiple elements of in-vehicle apparatus card information in the storage section 26 of the in-vehicle apparatus 20. The storage section 26 of the in-vehicle apparatus 20 may store multiple elements of in-vehicle apparatus card information through repetition of the method with which the user himself or herself of the in-vehicle apparatus 20 uses the portable terminal 40 to register the in-vehicle apparatus card information to the in-vehicle apparatus 20 as described with reference to FIG. 5. Further, the storage section 26 of the in-vehicle apparatus 20 may store multiple elements of in-vehicle apparatus card information through repetition of the method with which the salesperson at a shop, a vehicle sales dealer, or the like registers the in-vehicle apparatus card information to the in-vehicle apparatus 20 as described with reference to FIG. 6.

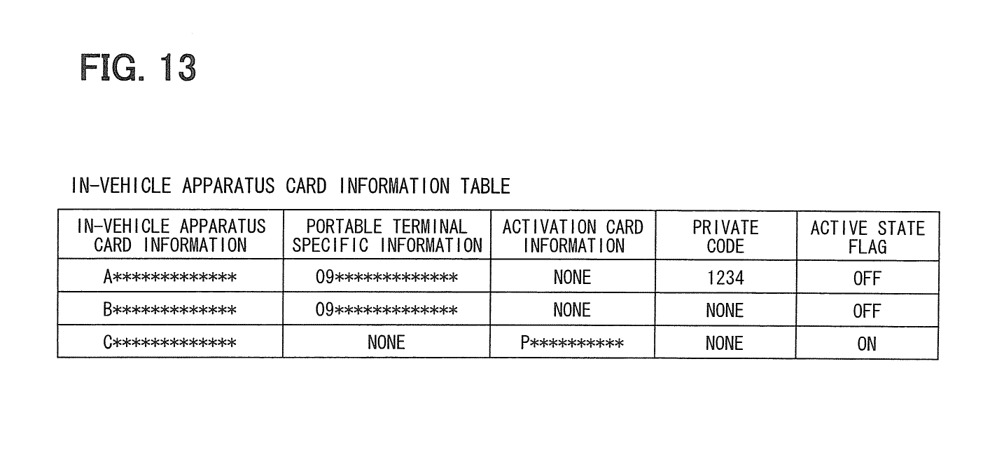

Furthermore, a preferable mode of storing the in-vehicle apparatus card information in the storage section 26 may be to store the in-vehicle apparatus card information in an in-vehicle apparatus card information table as shown in FIG. 13, for example. That is, the in-vehicle apparatus card information table has multiple records including such items as the in-vehicle apparatus card information, portable terminal specific information, activation card information, private code, and active state flag. The table contains no or only one record whose active state flag is turned “on.”

According to the above described configuration, the user can selectively use multiple elements of charging information as needed for execution of the charging process.

Moreover, when the storage section 26 is configured to store multiple elements of in-vehicle apparatus card information, it may be preferable to configure the storage section 26 to store the usage history information as well corresponding to the in-vehicle apparatus card information used when the usage history was created. And, when the usage history information is read, it may be preferable to output only the usage history information corresponding to the in-vehicle apparatus card information whose active state flag is turned “on.” Furthermore, it may be also preferable to output only the usage history information about the in-vehicle apparatus card information corresponding to the portable terminal specific information received from the portable terminal 40.

According to the above described configuration, it is possible to maintain privacy of the usage history information.

(5) In the above-mentioned embodiment, S405 of the in-vehicle apparatus process (FIG. 7) determines whether or not the ignition switch state changes from “off” to “on.” Instead, it may be preferable to determine whether or not to receive notification of “releasing a door lock” from a keyless entry ECU. Further, S450 determines whether or not the ignition switch state changes from “on” to “off.” Instead, it may be preferable to determine whether or not to receive notification of “releasing the door lock according to an instruction from outside the vehicle” from the keyless entry ECU. Such configurations can also provide the same effects.

(6) It may be preferable to change the lighting state of the HMI 23 (specifically an LED) in accordance with the active state flag state (“on” or “off”). For example, it may be possible to light a blue LED when the active state flag state is “on.” It may be possible to prevent the blue LED from lighting when the active state flag state is “off.” Further, when the wireless antenna 21 contains an LED, it may be preferable to change the lighting state or the like of the LED. According to the above described configuration, the user can visually check the lighting state or the like of the LED and can recognize the active state flag state, that is, whether or not the in-vehicle apparatus card information is available.

(7) According to the above-mentioned embodiment, except the user operation, the automatic activation flag state changes from “on” to “on” when the security ECU issues the theft detection signal (Yes at S710) or the constantly supplied power (so-called +B) is removed from the in-vehicle battery (Yes at S715). In addition, there may be a case where the control section 27 of the in-vehicle apparatus 20 is connected to a communication module or the like connectable to a wide-area wireless communication network. In such case, the control section 27 may receive a command for changing the automatic activation flag state from “on” to “off” from a user or a security center via the communication module or the like. Also in the above described case, it may be preferable to change the automatic activation flag state from “on” to “off.” The above described configuration may improve security of the in-vehicle apparatus card information.

(8) The notification process 1 is configured to start execution when called at S410 of the in-vehicle apparatus process S515 and S550 of the state change process as mentioned above. At S805, the notification process 1 is configured to notify the user of the in-vehicle apparatus card information state. The user may disable the notification. Specifically, it may be preferable to vary a flag that is provided for the storage section 26 and indicates whether or not to provide the notification based on an operation performed via the HMI 23. Reference to the flag state may make it possible to determine whether or not to provide the notification. According to the above described configuration, it is possible to reduce annoyance the user may feel as to the notification.

(9) At S760, the in-vehicle apparatus card information erasure process determines whether or not the storage section 26 stores the entrance information. It may be preferable to determine whether or not the storage section 26 stores barrier information or vehicle information corresponding to the in-vehicle apparatus card information to be erased instead of or in addition to the entrance information. The barrier information indicates which check barrier is passed. The vehicle information includes information indicating a vehicle type, vehicle number information, captured vehicle video information, and the like. The above described configuration can more effectively prevent occurrence of a problem of unsuccessfully passing through an exit tollbooth.

(Technical Terms)

The technical terms used in the above-mentioned embodiment are replaceable as needed. That is, the in-vehicle apparatus card information can be referred to as charging information. The portable terminal specific information or the activation card information can be referred to as activation-ready information. The storage section 26 can be referred to as a charging information storage section in which the section can be replaced by a means or a unit, a flag storage section in which the section can be replaced by a means or a unit, or a history information storage section in which the section can be replaced by a means or a unit. Further, the control section 27 can be replaced by a setup section in which the section can be replaced by a means or a unit. Moreover, the HMI 23 (specifically an operation button) or the operation section of the navigation system connected to the in-vehicle apparatus 20 can be separately referred to as a first operation acceptance section in which the section can be replaced by a means or a unit, a second operation acceptance section in which the section can be replaced by a means or a unit, or a third operation acceptance section in which the section can be replaced by a means or a unit, depending on purposes. Furthermore, the HMI 23 (specifically a speaker) can be referred to as an output section in which the section can be replaced by a means or a unit. Still further, S140 and S150 in FIG. 5 can be referred to as functions of the charging information storage section in which the section can be replaced by a means or a control unit. S440 in FIG. 7 can be referred to as a function of a history information output section in which the section can be replaced by a means or a unit. The in-vehicle apparatus card information erasure process in FIG. 11 can be referred to as a function of a charging information erase section in which the section can be replaced by a means or a unit.

The above-mentioned processes, steps, or means can be embodied as software units (e.g., subroutines) and/or hardware units (e.g., circuits or integrated circuits) including or excluding functions of associated devices. Further, a hardware unit can be formed inside a microcomputer. Moreover, a software unit or a combination of multiple software units can be included in a software program. The software program can not only be included in a computer-readable medium but can also be downloaded via a communication network and installed on a computer.

Various aspects of the above-mentioned disclosure are expressed as follows.

As one aspect, an in-vehicle apparatus includes: a charging execution section that communicates with a roadside apparatus and executes a charging process; a charging information storage section that stores charging information needed to execute the charging process by the charging execution section; and a setup section that assigns one of an active state equivalent to an available state and an inactive state equivalent to an unavailable state to the charging information stored in the charging information storage section. Examples of the charging information include card information, account information, user information, and the like for specifying a charging target, for example.

According to such in-vehicle apparatus, the setup section can enable the inactive state for the charging information stored in the charging information storage section. In such a manner, it is possible to disable the charging process for a toll fare using the in-vehicle apparatus. Therefore, it is possible to prevent the unauthorized use of charging information when a user leaves the vehicle. Since the charging information is not erased, it is considered to consume a shorter amount of time by a process that needs to use the charging information than the case when the charging information is erased. Not erasing the information is considered to minimize degradation of usability of the in-vehicle apparatus.

As an example in which the setup section enables the inactive state for the charging information, there may be a case where state information about the ignition switch is acquired and the ignition switch changes the on state to the off state. When the charging information is in the active state in such case, it may be preferable to change the charging information to the inactive state. Incidentally, the “ignition switch” signifies a switch that enables the vehicle to run. Specifically, the ignition switch is equivalent to a switch or a push switch housed in a key cylinder. The ignition switch signifies a switch for starting or stopping supplying accessory power, a switch for starting or stopping an engine, and the like.

The above described configuration can enable the inactive state for the charging information with no need for the user (driver) to perform a special operation for enabling the inactive state for the charging information. The usability is improved.

In addition, the in-vehicle apparatus may be configured to further include a first operation acceptance section that accepts an operation for changing the charging information from the active state to the inactive state from the user. The setup section may be configured to change the charging information from the active state to the inactive state when the first operation acceptance section accepts an operation for changing the charging information from the active state to the inactive state.

The above described configuration can allow the user to explicitly enable the inactive state for the charging information. The user can have a strong sense of safety. That is, the user can enable the inactive state for the charging information using an intuitive operation when the user leaves the vehicle for a short time, for example. Even in the possible event that the vehicle is stolen, the charging information can not be used by a thief. The user can leave the vehicle with security.

On the other hand, as an example in which the setup section enables the active state for the charging information, the in-vehicle apparatus may be configured to further include a second operation acceptance section for accepting an operation to input the private code from the user. The setup section determines whether or not the private code accepted by the second operation acceptance section is the same as the predetermined private code. When it is determined that both private codes are the same, the setup section may change the charging information from the inactive state to the active state.

Since the private code can be managed secretly according to the above described configuration, only a person that knows the private code can perform the charging process by using the charging information while preventing the unauthorized use of the charging information when the user leaves the vehicle.

Further, the setup section may determine whether or not activation-ready information entered from another apparatus is the same as the already input and stored information. When it is determined that both information are the same, the setup section may change the charging information from the inactive state to the active state. Incidentally, the “other apparatus” may represent a mobile telephone, navigation system, wrist watch, and the like.

According to the above described configuration, only a person that owns an apparatus capable of storage, generation, output, and the like of the activation-ready information can perform the charging process by using the charging information while preventing the unauthorized use of the charging information when the user leaves the vehicle.

Incidentally, in the above described case, the activation-ready information is preferably specific to the other apparatus mentioned above. For example, the specific information may include a hardware-specific ID of the other apparatus, a telephone number and the like when the other apparatus has a verbal communication function.

In such a manner, when the activation-ready information is specific to the other apparatus, the activation-ready information can be easily ensured to be unique. It is possible to easily improve safety of the charging information.

Further, the setup section may be configured to receive notification of having released the door lock from the keyless entry ECU and change the charging information, when set to the inactive state, to the active state.

According to the above described configuration, the user (driver) need not perform a special operation for enabling the active state for the charging information. Just releasing the door lock can enable the active state for the charging information. The usability is improved.

Further, the in-vehicle apparatus may be configured to further include a flag storage section for storing a flag that indicates whether or not to enable the active state for the charging information. The setup section acquires state information about the ignition switch. When the ignition switch state changes from off to on, the setup section may activate the charging information based on the flag stored in the flag storage section.

The above described configuration can improve the usability for the user while ensuring the safety of the charging information by appropriately controlling the state of the flag stored in the flag storage section.

By the way, it may be preferable for the user to be able to recognize the state of the charging information when there occurs a possibility of executing the charging process by the in-vehicle apparatus in such case that the user gets in the vehicle. The reason is as follows. When a long time passes after the user gets out of the vehicle, for example, the user may forget that the charging information is in the inactive state and that he or she needs to set the charging information to the active state. Therefore, the in-vehicle apparatus may be configured to further include an output section for outputting information indicative of the state of the charging information stored in the charging information storage section upon detection that the user performs a specified driving preparation operation for the vehicle. Incidentally, the “specified driving preparation operation” signifies an operation performed by the user when starting driving the vehicle and represents operations of opening or closing the vehicle door, unlocking the door, using the ignition key, setting the navigation system, and the like, for example.

According to the above described configuration, the user can certainly confirm the inactive state of the charging information. Therefore, it is possible to prevent occurrence of such a trouble such as that the user forgets to set the charging information to the active state and is forced to stop at the tollbooth.

Further, the in-vehicle apparatus may be configured to further include an output section for outputting information indicative of the state, when set to the inactive state, of the charging information stored in the charging information storage section upon detection that the user performs the specified driving preparation operation for the vehicle.

According to the above described configuration, the user can confirm the inactive state of the charging information with certainty. It is also possible to prevent occurrence of such a trouble that the user forgets setting the charging information to the active state and is forced to stop at the tollbooth. Further, no notification is provided when the charging information is in the active state. It is possible to reduce annoyance the user may feel as to the notification.

Further, the in-vehicle apparatus may be configured to further include an output section for outputting information indicative of the state of the charging information stored in the charging information storage section when a route for guidance provided by the navigation system is detected to include a place capable of executing the charging process and the charging information is set to the inactive state.

According to the above described configuration, it is possible to prevent occurrence of such a trouble that the user forgets setting the charging information to the active state and is forced to stop at the tollbooth. Further, it is possible to eliminate notification (unnecessary notification) for advising the user to enable the active state even though the charging information is not used. It is possible to reduce annoyance the user may feel as to the notification.

By the way, the charging information storage section is configured to store multiple elements of charging information. The setup section may preferably operate so that all the elements of the charging information stored in the charging information storage section are set to the inactive state or only any one thereof is set to the active state.

According to the above described configuration, the user can store multiple elements of charging information in the in-vehicle apparatus and allow the in-vehicle apparatus to execute the charging process using any of the stored charging information.

Incidentally, there may be a case where activation-ready information input from another apparatus is used to change the charging information from the inactive state to the active state and multiple elements of charging information can be stored. In such case, the charging information storage section may be configured to store the charging information and the activation-ready information in association with each other. In addition, the setup section may be configured to change the charging information corresponding to the activation-ready information input from another apparatus from the inactive state to the active state.

According to the above described configuration, the user can selectively use multiple elements of charging information as needed for execution of the charging process.

Further, in such a case, the in-vehicle apparatus may be configured to further include a charging information acquisition section that acquires the charging information and the activation-ready information from another apparatus and allows the charging information storage section to store both information in association with each other.

According to the above described configuration, the charging information storage section can reliably store the charging target information and the activation-ready information in association with each other. Moreover, it is possible to store the charging target information and the activation-ready information at a time.

Further, the in-vehicle apparatus may be configured to further include a history information storage section that stores history information about the charging process performed by the charging execution section in association with the charging information used for the charging process.

According to the above described configuration, it is possible to acquire only the history information about the charging process using specific charging information from the in-vehicle apparatus.

In the case of the above described configuration, the in-vehicle apparatus may be configured to further include a history information output section that reads, from the history information storage section, history information corresponding to the charging information corresponding to the activation-ready information input from another apparatus and outputs the history information.

According to the above described configuration, only a person that owns an apparatus for setting the charging information to the active state can output history information about the charging process based on the charging information. Accordingly, it is possible to protect privacy of the history information.

Further, the in-vehicle apparatus may be configured to further include: a third operation acceptance section for accepting an operation from a user associated with erasing charging information stored in the charging information storage section; a charging information erase section for erasing charging information stored in the charging information storage section when the third operation acceptance section accepts the operation; and a control information storage section for storing control information acquired from the charging process. Moreover, the charging execution section may be configured to allow the control information storage section to store control information from the charging process performed at an entrance tollbooth. In addition, the charging execution section may be configured to erase the control information when the charging process is performed at an exit tollbooth. The charging information erase section may be configured to erase charging information to be erased from the charging information storage section on condition that the control information storage section does not store control information corresponding to the charging information to be erased. The “control information” may represent, for example, entrance information indicating from which entrance tollbooth the vehicle enters the toll road, barrier information indicating which check barrier is passed, vehicle information including information indicating a vehicle type, vehicle number information, captured vehicle video information, and the like.

According to the above described configuration, it is possible to erase unnecessary charging information from the charging information storage section. In addition, it is possible to prevent occurrence of such a problem that necessary charging information is erased at an exit tollbooth and the vehicle cannot pass through the exit tollbooth.

Further, as another aspect, the disclosure may be understood as a semiconductor device that can be provided with the configuration described as to the setup section in the above-mentioned in-vehicle apparatus. Moreover, as still another aspect, the disclosure may be understood as a semiconductor device characterized by assigning one of an active state equivalent to an available state and an inactive state equivalent to an unavailable state to the charging information needed to execute the charging process. Such semiconductor device may be built in the in-vehicle apparatus equipped with the charging execution section for communicating with a roadside apparatus to execute the charging process and the charging information storage section for storing charging information needed to execute the charging process. In such a manner, it is possible to prevent the unauthorized use of charging information when a user leaves the vehicle. Furthermore, since the charging information is not erased, it is considered to take a shorter time consumed by a process needed to use the charging information than the case of erasing the charging information. It is considered to minimize degradation of usability of the in-vehicle apparatus.

While there have been described specific embodiments of the present invention, it is not to be understood that the embodiments are described with intent to limit the invention to the individually described embodiments. On the contrary, it is to be understood that the invention includes all modifications, equivalents, and alternatives belonging to the scope of the invention as defined by the appended claims.

What is claimed is:

1. An in-vehicle apparatus comprising:
a charging execution section that communicates with a roadside apparatus and executes a charging process;
a charging information storage section that stores charging information needed to execute the charging process by the charging execution section; and
a setup section that assigns one of an active state and an inactive state to a state of the charging information stored in the charging information storage section, the active state corresponding to an available state of the charging information and the inactive state corresponding to an unavailable state of the charging information.

2. The in-vehicle apparatus according to claim 1,
wherein the setup section acquires state information about an ignition switch and, when the ignition switch changes from an on-state to an off-state, the setup section changes the charging information to the inactive state when the charging information is in the active state.

3. The in-vehicle apparatus according to claim 1, further comprising:
a first operation acceptance section that accepts from a user a first operation associated with changing the charging information from the active state to the inactive state,
wherein the setup section changes the charging information from the active state to the inactive state when the first operation acceptance section accepts the first operation for changing the charging information from the active state to the inactive state.

4. The in-vehicle apparatus according to claim 1, further comprising:
a second operation acceptance section that accepts from a user a second operation to input a private code for changing the charging information from the inactive state to the active state,
wherein the setup section determines whether or not the private code accepted by the second operation acceptance section is the same as a predetermined private code, and
wherein, when it is determined that the private code and the predetermined private code are the same, the setup section changes the charging information from the inactive state to the active state.

5. The in-vehicle apparatus according to claim 1,
wherein the setup section determines whether or not activation-ready information entered from an other apparatus is the same as already input and stored information and, when it is determined that the activation-ready information and the already input and stored information are the same, the setup section changes the charging information from the inactive state to the active state.

6. The in-vehicle apparatus according to claim 5,
wherein the activation-ready information is specific to the other apparatus.

7. The in-vehicle apparatus according to claim 1,
wherein the setup section receives notification of a release of a door lock from a keyless entry ECU and changes the charging information to the active state when the charging information is set to the inactive state.

8. The in-vehicle apparatus according to claim 1, further comprising:
a flag storage section for storing a flag that indicates whether or not to enable the active state for the charging information,
wherein the setup section acquires state information about the ignition switch and, when an ignition switch state changes from an off-state to an on-state, the setup section activates the charging information based on the flag stored in the flag storage section.

9. The in-vehicle apparatus according to claim 1, further comprising:
an output section for outputting information indicative of the state of the charging information stored in the charging information storage section upon detection that a user performs a specified driving preparation operation for the vehicle.

10. The in-vehicle apparatus according to claim 1, further comprising:
an output section for, when the state of the charging information stored in the charging information storage section is set to the inactive state, outputting information indicative of the state of the charging information upon detection that a user performs a specified driving preparation operation for the vehicle.

11. The in-vehicle apparatus according to claim 1, further comprising:
an output section for outputting information indicative of the state of the charging information stored in the charging information storage section when a route for guidance provided by a navigation system is detected to include a place capable of executing the charging process and the charging information is set to the inactive state.

12. The in-vehicle apparatus according to claim 1,
wherein the charging information storage section is capable of storing multiple elements of charging information, and
wherein the setup section is configured so that all the elements of the charging information stored in the charging information storage section are set to the inactive state or only any one thereof is set to the active state.

13. The in-vehicle apparatus according to claim 1,
wherein the charging information storage section stores the charging information and the activation-ready information in association with each other,
wherein the setup section determines whether or not activation-ready information entered from another apparatus is the same as already input and stored information, and
wherein, when it is determined that both information are the same, the setup section changes the charging information from the inactive state to the active state and changes the charging information corresponding to the activation-ready information entered from the other apparatus from the inactive state to the active state.

14. The in-vehicle apparatus according to claim 13, further comprising:
a charging information acquisition section that acquires the charging information and the activation-ready information from the other apparatus and allows the charging information storage section to store the both of the information in association with each other.

15. The in-vehicle apparatus according to claim 12, further comprising:
a history information storage section that stores history information about the charging process performed by the charging execution section in association with the charging information used for the charging process.

16. The in-vehicle apparatus according to claim 15, further comprising:
a history information output section that reads, from the history information storage section, the history information corresponding to the charging information corresponding to the activation-ready information input from the other apparatus and outputs the history information.

17. The in-vehicle apparatus according to claim 1, further comprising:
a third operation acceptance section for accepting from a user a third operation associated with erasing the charging information stored in the charging information storage section;
a charging information erase section for erasing the charging information stored in the charging information storage section when the third operation acceptance section accepts the third operation; and
a control information storage section for storing control information acquired from the charging process,
wherein the charging execution section allows the control information storage section to store the control information from the charging process performed at an entrance tollbooth and erases the control information when the charging process is performed at an exit tollbooth, and
wherein the charging information erase section erases charging information to be erased from the charging information storage section on condition that the control information storage section does not store the control information corresponding to the charging information to be erased.

18. A semiconductor device having a configuration described with respect to the setup section in the in-vehicle apparatus according to claim 1.

19. A semiconductor device characterized by assigning one of an active state and an inactive state to a state of charging information needed to execute a charging process, the active state corresponding to an available state of the charging information and the inactive state corresponding to an unavailable state of the charging information.
